(19) United States
(12) Patent Application Publication
(10) Pub. No.: US 2023/0418896 A1
(43) Pub. Date: Dec. 28, 2023

(54) SOLVING A SET OF (NON)LINEAR DIFFERENTIAL EQUATIONS USING A HYBRID DATA PROCESSING SYSTEM COMPRISING A CLASSICAL COMPUTER SYSTEM AND A QUANTUM COMPUTER SYSTEM

(71) Applicant: QU & CO R&D B.V., Amsterdam (NL)

(72) Inventors: Vincent Emanuel Elfving, Amsterdam (NL); Oleksandr Kyriienko, Amsterdam (NL); Annie Emma Paine, Amsterdam (NL)

(21) Appl. No.: 18/252,961

(22) PCT Filed: Nov. 15, 2021
(86) PCT No.: PCT/EP2021/081737

§ 371 Date: May 15, 2023

(30) Foreign Application Priority Data
Nov. 15, 2020 (EP) 20207672.5
Apr. 9, 2021 (EP) 21167715.8
Sep. 17, 2021 (EP) 21197576.8
Oct. 29, 2021 (EP) 21205728.5

(51) Int. Cl. G06F 17/13

(52) U.S. Cl. CPC G06F 17/13

(57) ABSTRACT

A method is described for solving a set of (non)linear differential equations, DEs, using a hybrid system comprising a classical computer and a quantum computer comprising receiving or determining, by the classical computer, a formulation of quantum circuits representing the DEs and being parameterized by variables x of the DEs and including function circuit(s) for determining trial functions value(s) f(xj) around point(s) xj and derivative function circuit(s) for determining trial derivative value(s) around the point(s) xj; executing, by the quantum computer, the quantum circuits for a set of points xj in the variable space x of the DEs; receiving, by the classical computer, in response to the execution of the quantum circuits quantum, hardware measurement data; and, determining, by the classical computer, on the basis of the quantum hardware measurement data and a loss function, if the quantum hardware measurement data forms a solution to the set of (non)linear DEs.

### FIELD OF THE INVENTION

The disclosure relates to quantum differential encoders and, in particular, though not exclusively, to methods and systems of solving a (non)linear set of differential equations using a quantum computer, and a computer program product enabling a data processing system comprising a quantum computer to solve set of (non)linear differential equations.

### BACKGROUND OF THE INVENTION

The calculus of infinitesimal changes has formed the paradigm for modelling phenomena in various areas of science. Written as a system of differential equations (DEs) of one or more variables, the solution typically allows to describe function behaviour in space and time, given the specified initial and boundary conditions. The range of applications for differential equations spans across all disciplines. In physics they encompass mechanics, electrodynamics, fluid dynamics, thermodynamics, and quantum theory. In chemistry, DEs describe chemical reactions and molecular dynamics. In biology they describe ecology and competition in the ecosystem. DEs are also a workhorse of epidemiology. In economy and finances they describe strategies for optimal pricing, hedging, and determination of optimal investment strategies.

For the cases that cannot be treated analytically, finding solutions to differential equations requires advanced numerical methods. These can be categorized into local and global methods. Local classical computational methods rely on discretization of the space of variables, often with a fine grid being required to represent a solution accurately. Moreover, as derivatives are approximated using numerical differentiation techniques (finite differencing and Runge-Kutta methods), small grid steps are required to reproduce the results qualitatively. This leads to large computational cost as the number of points M (degrees of freedom) grows. Moreover, lattice-based calculations for increasing dimensionality of the problem (equal to the number of variables v) leads to a ‘blow-up’ of required number of points as ˜M^{v}, a phenomenon known as ‘the curse of dimensionality’. Global (spectral) numerical methods for solving differential equation rely on representing the solution in terms of a suitable basis set. This recasts the problem to finding optimal coefficients for the polynomial (e.g. Fourier or Chebyshev) approximation of the sought function. While in some cases spectral methods may more efficiently find optimal solutions, for finding general functions the same problem of dimensionality applies, as the required basis set size can grow rapidly for complex solutions and differentiation still requires performing numerical approximations. Finally, unlike linear systems of algebraic equations, nonlinear differential equations can be stiff with solutions being unstable for certain methods. Such systems are difficult to solve due to large change of solution in the narrow interval of parameters. Furthermore, challenging problems correspond to systems with highly oscillatoric solutions and discontinuities. Yet again it requires considering fine grids and large basis sets, together with applying meticulous numerical differentiation techniques.

A prominent example of a field where complex differential equations are widespread is fluid dynamics. Fluid dynamics studies the flow of Newtonian fluids, with corresponding Navier-Stokes differential equations derived based on energy and momentum conservation laws. Being highly nonlinear, they are rarely solveable with analytical methods and therefore they are treated within the computational fluid dynamics discipline. Solving these equations is vital to many industrial applications; this includes propulsion and aircraft construction (airspace industry), engine design (automotive industry), submarine design (naval industry), oil wells (drilling industry), blood flow in capillar tubes (health industry), weather forecasting and climate modelling, among many others. Taking a solid share of computational time on large-scale classical computers, efficient solving of systems of differential equations is an outstanding open problem.

Quantum computers change the way we process information. For certain problems they offer drastic computational speed up, ranging from quadratic acceleration of searching unstructured data, to exponential improvements for factoring large numbers used in encryption applications. Using qubits and coherent superpositions of binary strings, quantum machines utilize quantum interference effects to amplify the correct solution, reached in fewer steps than classical computers ever can. Quantum computers are well-suited for chemistry applications, as they are naturally suitable for the simulation of certain quantum processes. At the same time, quantum computers are not directly suited for all computational problems, and can be seen as specialized machines (akin to GPUs), that need to be tailored to the problem at hand. Designing these machines and their operational schedule is crucial for solving problems in quantum computers faster than any available classical methods. This remains true for tasks and applications in differential calculus.

To date, few studies asked the question if quantum processors can be capable of solving systems of differential equations. This mostly builds on the known quantum algorithms for solving linear systems of equations known as HHL algorithm [HHL 2009] and its improvements. To be precise, a quantum version of the problem is solved, where variable is sought as a quantum state |x [symbol] =Ã⁻¹|b [symbol] for the matrix Ã and a vector of constant terms needs to be loaded as a quantum state |b [symbol] . This is named as an amplitude encoding, where any function can be represented as a quantum state |u [symbol] =Σₖ₌₁²^{^{N}}uₖ|k [symbol] for N qubits. Here |k [symbol] denote discretized points of space/time, and amplitudes uₖ encode values of a function at these points (Σₖ|uₖ|²=1) due to normalization of the quantum wavefunction. Amplitude encoding is also known as ‘analogue encoding’ Ref. [Mitarai 2019], and is for instance used in the HHL protocol [HHL 2009], which in many cases conceptually can be seen as a parent to various linear ODE solvers.

Using a finite differencing scheme (Euler's method), several studies reduced DEs to algebraic equations, utilizing similar approach. They also need to be linearized, increasing overhead in the number of equations. A direct treatment of nonlinear differential equations by a quantum algorithm remains an open challenge.

In general, compressing 2^{N}-dimensional data into an N-qubit register is beneficial due to exponential memory savings. However, as highlighted in the review Ref. [Biamonte 2018] several problems arise; first, creating an exponentially compressed state from a vector of constants is a serious problem, that requires sophisticated techniques like quantum random access memory (QRAM) and may require exponentially many gate operations for preparing a general state, resulting in an exponential scaling of the algorithmic runtime. For ODEs, this appears at the level of preparing an arbitrary initial condition. Second, reading out the result is complicated, as sampling from a quantum state requires exponentially many samples in the number of qubits for a given numerical accuracy. Finally, the required depth of HHL-like protocols for industrially relevant problems is huge even for fault-tolerant quantum devices. Taking the simulation of electromagnetic wave scattering as an example, and considering the cost of implementing oracles, a circuit that simulates an industrially relevant challenge was estimated to require 10⁸ qubits and 10²⁹ gates Ref. [Scherer 2017]. Even with extremely fast gates this runtime is on the cosmic scale.

Current quantum devices are prone to noise and are not suited for large depth quantum circuits. However, the Hilbert space of these devices increases exponentially with the number of qubits, providing advantage over classical methods for certain problems. Quantum processors with about ˜100 qubits may offer computational power inaccessible to classical computers. This corresponds to Noisy Intermediate Scale Quantum (NISQ) processors, that are special purpose devices that need to be co-designed with a problem in mind. A particularly useful approach in this setting is to use variational quantum algorithms (VQA). Initially proposed for chemistry under the name of variational quantum eigensolver (VQE), this approach queries a quantum computer to prepare low energy states on a quantum devices, but guiding the optimization loops using a classical computer. This strategy has allowed to perform quantum calculations with relatively noisy devices, allowing for numerous advances, unmatched by current large-depth protocols. This has triggered the attention to generic VQA's, finding applications in many application areas including data science and quantum simulation.

One variational approach which aims to solve differential equations on a quantum computer is described in Ref. [Lubasch 2020]. That proposed approach also allows to implement nonlinear terms, using ‘quantum nonlinear processing units’, albeit at the expense of adding complex ancillary-based operations with a K-fold increase of the system size (K is the order of the non-linearity in the differential equation). Importantly, the approach is based on the amplitude encoding of the function |u [symbol] =Σₖ₌₁²^{^{N}}uₖ|k [symbol] , where 2^{N} bitstrings (for N qubits) label the grid points for the variable; in addition, the method uses approximate numerical differentiation techniques. Moreover, as the goal of the algorithm is to prepare a state |u(x) [symbol] as a function of discretized variable x, the outstanding challenge corresponds to reading out exponentially many amplitudes if the full function behaviour is needed.

Another work relevant in the current context is Ref. [Gaitan 2020] where numerical approaches to fluid dynamics problems are considered. The proposed approach relies on finite-difference methods with grid-based calculations. The workflow of the algorithm represents a classical CFD algorithm with a single step that is delegated to quantum hardware. The latter corresponds to function averaging as performed in Kacewicz' quantum ODE algorithm, with the core subroutine being quantum amplitude estimation algorithm (QAEA). QAEA is a Grover search-type algorithm that provides a quadratic quantum speed once the desired function is prepared as a quantum state and two quantum Fourier transforms (direct and inverse) are performed. Since the function averaging is based on amplitude-encoded state, and assumes that a black-box oracle for this operation is available, it is difficult to estimate the algorithm complexity. Also, unfortunately the input problem (QRAM requirement) arises here.

Hence, from the above, it follows that there is therefore a need in the art for improved methods and systems for solving different types of (non-)linear differential equations using quantum computers. In particular, there is a need in the art to improve the approximation of trial function derivatives, as well as efficiently encoding the solution in a quantum representation that should be easily loaded, processed and read out, as well as providing a framework that is compatible with near-term quantum hardware with limited circuit depth, as well as extensibility to fault-tolerant hardware.

### REFERENCES

[HHL 2009] https://doi.org/10.1103/PhysRevLett.103.150502
[Gaitan 2020] https://doi.org/10.1038/s41534-020-00291-0
[Mitarai 2018] https://doi.org/10.1103/PhysRevA.98.032309
[Mitarai 2019] https://doi.org/10.1103/PhysRevA.99.012301
[Biamonte 2018] https://doi.org/10.1038/nature23474
[Lubasch 2020] https://doi.org/10.1103/PhysRevA.101.010301
[Scherer 2017] https://doi.org/10.1007/s11128-016-1495-5

### SUMMARY OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. Additionally, the Instructions may be executed by any type of processors, including but not limited to one or more digital signal processors (DSPs), general purpose microprocessors, application specific integrated circuits (ASICs), field programmable logic arrays (FP-GAs), or other equivalent integrated or discrete logic circuitry.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is an objective of the embodiments in this disclosure to reduce or eliminate at least part of the drawbacks known in the prior art. In particular, it is an object of the embodiments in this application to efficiently encode the differential equation trial solution in a quantum representation that is easily loaded, processed and read out. A further object of the embodiments is to compute analytical derivatives of trial solutions, instead of numerical approximations. It is a yet further object of the embodiments to provide a framework that is compatible with the limited coherence time and available quantum circuit gate depth of near-term quantum hardware. It is also an object of the embodiments to make use of the increased fault-tolerancy of projected future quantum hardware. It is also an object of the embodiments to allow for general solutions to general sets of differential equations, including non-linear components and components representing complex oscillatory and/or non-trivial behavior. It is also an object of the embodiments to allow for solving parametric differential equations where the parameters or terms of the equation are not known to high accuracy, while additional data points (measurements) are available to perform partial regression and for mitigating such uncertainty. It is also an object of the embodiments to allow for solving parametric differential equations where it is not known that all terms of the equation accurately describe the data with a finite coefficient or not, where a trade-off is required to ensure interpretability.

In an aspect, the invention may relate to a method for solving one or more differential equations DEs, e.g. a set of (non)linear differential equations, using a data processing system comprising a classical computer system and a quantum computer system. The method may comprise: receiving or determining, by the classical computer system, a formulation of quantum circuits representing the one or more DEs, the quantum circuits being parameterized by variables x of the one or more DEs and including one or more function circuits for determining one or more trial functions values ƒ(xⱼ) around one more points xⱼ and one or more derivative function circuits for determining one or more trial derivative values around the one or more points xⱼ; executing, by the quantum computer system, the quantum circuits for a set of points xⱼ in the variable space X of the one or more DEs; receiving, by the classical computer system, in response to the execution of the quantum circuits quantum, hardware measurement data; and, determining, by the classical computer system, on the basis of the quantum hardware measurement data and a loss function, if the quantum hardware measurement data forms a solution to the one or more DEs.

In a further aspect, the invention may relate to a method for solving one or more differential equations, DEs, using a data processing system comprising a classical computer system and a quantum computer system, wherein the method may comprise: receiving or determining, by the classical computer system, a formulation of quantum circuits representing a trial function for the one or more DEs, the trial function being associated with one or more variables and a variable space, the quantum circuits including one or more function circuits for determining one or more values of the trial function around one or more points in the variable space, one or more derivative function circuits for determining one or more values of an derivative of the trial function around the one or more points and one or more quantum variational circuits associated with one or more optimization parameters; executing, by the classical computer system, the quantum circuits for a set of points in the variable space of the trial function, wherein the execution of the quantum circuits includes: translating the quantum circuit into control signals for controlling quantum elements of the quantum computer system and for readout of the quantum elements to obtain hardware measurement data and controlling the quantum computer system based on the control signals; receiving, by the classical computer system, in response to the execution of the quantum circuits, the hardware measurement data and processing the hardware measurement data into one or more trial functions and one or more derivatives of the one or more trial functions; determining, by the classical computer system, on the basis of the one or more trial functions, the one or more derivatives of the one or more trial functions and a loss function, a score indicating how well the one or more measured trial functions satisfy the one or more DEs.

In an embodiment, the method may include optimizing the loss function, the optimization including adjusting the one or more optimization parameters and repeating the execution of the quantum circuits, the processing of the hardware measurement data and the determination of a score, until the score meets a predetermined optimization condition.

In an embodiment, the one or more derivative function circuits may be obtained by analytic differentiation of the one or more function circuits with respect to the one or more variables

Thus, the embodiments in this application allows solving differential equations, including nonlinear differential equations, of a general form using a quantum computer in a way that is substantially different from the schemes known in the prior art. For a given set of nonlinear differential equations, quantum circuits are constructed on the basis of so-called differentiable quantum circuits (DQCs). These quantum circuits may be executed on the quantum computer and a cost function, e.g. an Hermitian operator such as a Hamiltonian, may be used to measured observables that form an approximation of the solution to the set of nonlinear differential equations are used in a classical optimization algorithm. A loss function may be used to determine if the approximation of the solution is sufficiently close to the solution to the set of nonlinear differential equations.

In an embodiment, the determining if the quantum hardware measurement data forms a solution to the one or more DEs may be further based on one or more boundary conditions associated with the one or more DEs

In an embodiment, if the one or more DEs represents one or more parameterized DEs, the determining if the quantum hardware measurement data forms a solution to the one or more DEs may be further based on one or more boundary conditions associated with the one or more DEs and one or more data points, for example measured data points.

In a further embodiment, the determining if the quantum hardware measurement data forms a solution to the one or more DEs may be based on regularization data representing initial estimated values for parameters used in the one or more parameterized DEs.

In an embodiment, the one or more DEs may include one or more parameterized DEs, and, wherein the determining if the quantum hardware measurement data forms a solution to the one or more DEs is further based on one or more boundary conditions associated with the one or more parameterized DEs and one or more data points, for example measured data points, and, optionally, regularization data representing initial estimated values for one or more parameters used in the one or more parameterized Des.

In an embodiment, the one or more DEs may include one or more parameterized DEs, wherein a right hand side RHS term of the one or more parameterized DEs define a parameterized linear combination of functionals; and, wherein the determining if the quantum hardware measurement data forms a solution to the one or more DEs is further based on one or more boundary conditions associated with the one or more parameterized DEs and one or more data points, for example measured data points, and, optionally, regularization data representing initial estimated values for one or more parameters used in the one or more parameterized DEs.

In an embodiment, the parameterized linear combination of functionals may define as vector inner product [symbol] ·F, wherein [symbol] defines a parameter in the form of a vector of coefficients and F is a vector of functionals on ƒ and x,

$$( F [ f , \frac{df}{dx} , x , … ] ) ;$$

and, optionally, the loss function including a regularization loss term based on the coefficients, preferably the norm of the coefficients.

In other words, the right-hand side RHS of this equation may be any linear combination of a set of library terms that are expected to be relevant to solving the differential equation. Then, during the loss function optimization, both the quantum circuit parametrization, θ as well as the function coefficients, [symbol] , may be optimized.

In an embodiment, executing the quantum circuits may include: translating each of the quantum circuits into a sequence of pulses; and, applying the sequence of pulses to the qubits of the quantum computer.

In an embodiment, receiving hardware measurement data may include: applying a read-out pulse signal to qubits of the quantum computer system and measuring quantum hardware measurement data.

In an embodiment, the quantum circuits may be parameterized based on at least an adjustable optimization parameter, wherein if it is determined that the quantum hardware measurement data do not form a solution, then adjusting the at least one adjustable optimization parameter to form adjusted quantum circuits and determining further quantum hardware measurement data based on the adjusted quantum circuits. Further, if the one or more DEs include one or more parameterized DEs, also at least one of the one or more parameters of the one or more parameterized DEs respectively may be adjusted.

In an embodiment, the function circuit may comprise a quantum feature map circuit for encoding a functional dependence, preferably a nonlinear dependence, on one or more variables x of the DEs into quantum wave amplitudes of the qubits of the quantum computer system.

In an embodiment, the quantum feature map circuits may be differentiable into a sum of modified quantum circuits.

In an embodiment, each of the one or more derivative function circuits comprise at least one of the modified quantum circuits.

In an embodiment, the one or more function circuits and/or the derivative circuits may further comprise a quantum variational ansatz circuit, which may be parameterized by an adjustable optimization parameter.

In an embodiment, the one or more derivative function circuits may represent analytical derivatives of the one or more function circuits in the variables x.

In an embodiment, the quantum circuits may represent one or more solutions to the set of DEs according to the functional F[{dⁿƒ/dxⁿ}ₙ,{ƒₘ(x)}ₘ]=0, wherein the functional F is determined by the system described by the (non)linear DEs.

Hence, the embodiments in this application use quantum feature map encoding to overcome the complexity of amplitude encoding that is used in the prior art for preparing the solution at the boundary; use automatic differentiation of the quantum feature map circuit, allow to represent analytical function derivatives without imprecision error characteristic to numerical differentiation (finite differencing);
use variational quantum circuits to search for a suitable solution in the exponential space of fitting polynomials, thus resembling the spectral and finite element methods with exponentially improved scaling; and, avoid the data readout problem, as the solution is encoded in the observable operator, such that expectation can be routinely calculated.

In an embodiment, the quantum hardware measurement data may include measured trial function values and measured trial differential values and the loss function may be used to determine if the measured trial function values and the measured differential values form a solution to the set of differential equations.

In an embodiment, receiving hardware measurement data may include: applying a read-out pulse signal to qubits of the quantum computer system and measuring quantum hardware measurement data.

In an embodiment, the quantum hardware measurement data may be measured as expectation values of a Hermitian cost operator, preferably a Hamiltonian operator.

In an embodiment, the quantum circuits may comprise a quantum feature map circuit, which encodes a (non-)linear function dependence on differential equation variable(s) x.

In an embodiment, the quantum feature map circuit may comprise a product-type feature map, a Chebyshev feature map, a Chebyshev sparse feature map, a Chebyshev tower feature map, a Fourier-type feature map, an Evolution-enhanced feature map, and amplitude-encoding feature map, or any other feature map

In an embodiment, the quantum circuits may comprise a variational quantum circuit, which can be used to variationaly optimize quantum ampltidues such that the cost function is minimized.

In an embodiment, the variational quantum circuit may include a hardware efficient ansatz or an alternating blocks ansatz

In an embodiment, the cost function may represent the differential equation's function value at a point xj.

In an embodiment, the cost function may be comprised of single-qubit operators, general Ising Hamiltionian operators, or chemistry-like general strings of Pauli-string operators which may or may not have variationally optimizable coefficients.

In an embodiment, the loss function may be based on mean-squared error, mean-absolute error, Kull-back-Leibler (KL) divergence, Jensen-Shannon divergence, or other error or divergence metrics.

In an embodiment, the boundary may be handled by a boundary-pinning strategy, a floating boundary strategy, or an optimized boundary handling.

In an embodiment, regularization prior information may be applied to help convergence and reducing risk of getting stuck in local minima.

In an embodiment, non-regularization (real) information, data points, physical measurements, or any other a-priori known data may be used to solve systems of parametric differential equations where parameters of the equation are not exactly known or known to low degree of confidence. Those data points may be considered in the total loss function in order to perform partial regression on the data while still conforming to the (set of) differential equations.

The invention may relate to a quantum-classical hybrid system for solving one or more of the following differential equations: ordinary differential equations ODE, partial differential equations PDE, stochastic differential equations SDE, higher-order DE, higher-degree DE, single- or multiple dimensional DE, one or more/sets of DE, elliptic/hyperbolic/parabolic PDE, initial value and/or boundary value problems, including Dirichlet and/or Neuman boundary condition, Cauchy-type, as well as Ribin and mixed boundary type, control-type problems, including but not limited to Hamilton-Jacobi Belman and Eikonal boundary value problems, delay differential equations, differential-algebraic equations (DAEs), real and complex-valued functions, solving non-linear stochastic differential equation, for example but not limited to those of Ito and Stratonovich form. The invention may further reside in one or more of the following embodiments.

In an embodiment, the variational quantum circuit may include a quantum gate sequence which can be used to variationally optimize quantum amplitudes such that the loss function L is minimized and one or more accurate solution(s) to one or more Differential equations can variationally be found

In an embodiment, the variational quantum circuit includes a hardware-efficient ansatz, where layers of parameterized quantum gate rotations are followed by layers of Controlled-NOT operations in alternating fashion, such that the logical circuit requirements map natively to the quantum hardware information carrier connectivity.

In an embodiment, the variational quantum circuit includes an alternating-blocks ansatz, preferably such that the circuit consists of gate blocks of width M/2 with M larger than 1 and smaller than the number of quantum information carriers1. The blocks are placed in a checker-board pattern, and repeated several times.

In an embodiment, the loss function may define an instruction for a classical computer on how to collect quantum measurement data and convert it to a single quantity (‘loss’) which quantifies the quality of the solution to the (set of) (non)linear differential equations. Preferably, the loss function comprises a differential loss term and a boundary term

In an embodiment, the distance definition of the loss is quantified by means of a Mean Squared Error (MSE) defined by (a−b)² for single-valued parameters a and b.

In an embodiment, the distance definition of the loss is quantified by means of a Mean Absolute Error (MAE) defined by |a−b| for single-valued parameters a and b.

In an embodiment, the distance definition of the loss is quantified by means of the Kullback-Leibler divergence, defined by the expectation of the logarithmic difference between the considered quantities.

In an embodiment, the distance definition of the loss is quantified by means of a Jensen-Shannon divergence.

In an embodiment, the boundary conditions to the set of one or more differential equations may be included as an additional consideration in the method. Preferably, these boundary conditions determine the specific solution of the differential equations.

In an embodiment, the boundary conditions may be included directly in the loss function as an additional term.

In an embodiment, the boundary conditions may be included in the cost operator C with a fixed additional term, presenting an equivalent treatment of boundary and derivative terms, both being encoded in the eigenspectrum of the cost operator.

In an embodiment, the boundary conditions are included via iteratively shifting the estimated trial solution based on the boundary or initial point, at each iteration of the classical computer's variational optimization sequence.

In an embodiment, the boundary conditions may be included via a classical shift of the solution defined by the gradient descent procedure on par with variational angles' optimization. Preferably this constitutes another variational parameter to be passed to the classical optimizer.

In an embodiment, the variational optimizer is prevented from getting trapped in local minima, by adding a regularization procedure. Preferably, this includes one or more of the following strategies: feeding in prior information about the potential solution; biasing the solution into a specific form; searching for a solution in a region close to the known boundary values of the differential equation(s).

In an embodiment, the regularization term is linearly decreasing in weight contribution to the loss function.

In an embodiment, the regularization term may be smoothly dropped at pre-defined training stages, which may in an embodiment correspond to a reverse sigmoid optimization schedule.

In an embodiment, the differential equation may be an Ordinary Differential Equation (ODE).

In an embodiment, the differential equation may be a Partial Differential Equation (PDE), where preferably several quantum feature map circuits are concatenated or interleaved.

In an embodiment, the differential equation may be a parameterized differential equation, where one or more of the elements in the equation are (hyper)parameters rather than functions (ƒ(x), g(x, y)) or dependent/dimensional variables (x, y, z, t). To solve such equations for a specific instance, additional data is required and used as boundary conditions on the parameters, and regularization in the form of initial suggested values for the parameters may be given.

In an embodiment, the differential equation may be a higher-order DE, where one or more functions are differentiated more than once.

In an embodiment, the differential equation may be of higher-degree or non-linear, where one or more functions are raised to a power other than zero or one, or argument to one or more non-linear functions themselves.

In an embodiment, the differential equation may depend on multiple unique variables x, y, z . . . , also known as dimensions.

In an embodiment, the differential equation considered may comprise a set of more than one differential equation.

In an embodiment, the differential equation may be an elliptic, hyperbolic or parabolic PDE.

In an embodiment, the differential equation considered describes an initial value and/or boundary value problem, including but not limited to Dirichlet-type

In an embodiment, the differential equation may have one or more boundary conditions of one of {Dirichlet, Neuman, Cauchy, Ribin, mixed}-type.

In an embodiment, the differential equation may describe a control-type problem, including but not limited to Hamilton-Jacobi Bellman equation, and Eikonal boundary value problems.

In an embodiment, the differential equation may constitute a (set of) delay differential equations.

In an embodiment, the differential equation may describe differential-algebraic equations (DAEs).

In an embodiment, the differential equation(s) include one or more (non-) linear stochastic differential equations, including but not limited to those of Ito and Stratonovich form.

Embodiments in this application may be implemented based on noisy quantum hardware with finite logical gate error and finite coherence times.

In an embodiment, the method may be based on noisy quantum hardware wherein the subroutines of the algorithm may be executed by multiple quantum devices operating in parallel and/or in series, routing measurement data to one classical computer which computes the loss function value each iteration.

In an embodiment, instead of measuring a cost function for each part in the loss function, one may rely on overlap estimations of left-hand-side and right-hand-side of the differential equations in functional form, wherein the quantum hardware quantum information overlap may be considered as a functional overlap.

In an embodiment, the quantum computer system may be implemented as a hardware quantum computer.

In an embodiment, the quantum computer system may comprise qubit-based quantum hardware, where the quantum information carriers are embodied by qubits or quantum bits.

In an embodiment, the quantum hardware may include a continuous-variable system, such that information carriers are defined by continuous quantum variables

In an embodiment, the quantum computer system may be implemented as a software program for simulating a quantum computer system comprising quantum processing elements, for example qubits. Hence, this embodiment, the software program may be a classical software program that runs a classical computer so that quantum algorithms associated with the embodiments in this application can be developed, executed and tested on a classical computer without requiring access to a hardware implementation of the quantum processor system.

In an embodiment, the quantum circuit may include a plurality of different quantum sub-circuits. In an embodiment, the one or more quantum sub-circuit may include one or more quantum feature circuits, each quantum feature circuit being configured to map a variable of the differential equation to a Hilbert space that is associated with the qubits of the quantum computer.

In an embodiment, the one or more quantum sub-circuit may include one or more variational quantum circuits associated with one or more variational parameters for training the quantum circuit to approximate a solution to the differential equation.

In an embodiment, the one or more quantum sub-circuit may include one or more initialization quantum circuits configured to initialize at least part of the variational parameters of the quantum circuit based on one or more initialization parameters.

In an embodiment, at least part of the variational parameters of the one or more variational quantum circuits may be initialized based on initialization values that are classically computed based on a classically simulable version of the quantum circuit that can simulated on a classical computer.

In an embodiment, the classical simulation may include: computing expectation values of the output of the classical simulable quantum circuit, the expectation values defining a function ƒ(\vec{x}); determining a dependent-variable dependence of ƒ(\vec{x}) as a function of initialization parameters \vec{θ}ᵢₙᵢ; determining optimal values for the initialization parameters \vec{θ}ᵢₙᵢ based on fitting ƒ(\vec{x}) to a desired (estimate of the) solution; initializing the quantum circuit based the optimal values for the initialization parameters \vec{θ}ᵢₙᵢ, while keeping the other variational parameters I the the classical simulable quantum circuit.

Thereafter, the quantum circuit may be variationally optimized based on the variational parameters until a predetermined convergence of the output of the quantum circuit with the actual solution is determined.

In an embodiment, the one or more quantum feature maps and the one or more variational quantum circuits, and cost function may be constructed so that the circuit operators exhibit a certain symmetry, such as real-value preserving features. In that case, circuit differentiation can be performed in N+1 evaluations instead of 2N parameter-shift evaluations, speeding up the calculation of function derivatives by an (asymptotic) factor of two.

In an aspect, the invention may relate to a process of initializing a quantum circuit representing a function or an equation. The quantum circuit may include one or more quantum sub-circuits, the one or more sub-circuits including one or more quantum feature maps, one or more variational quantum circuits, and one or more initialization unitary quantum circuits. In an embodiment, a classically simulable quantum circuit associated with the quantum circuit may be determined. To that end, in an embodiment, a relation between at least part of the variational parameters of the one or more variational quantum circuits may be defined so that the quantum circuit defines a classically simulable quantum circuit.

Expectation values at the output of the classically simulable quantum circuit may be determined by simulating the classically simulable quantum circuit using a classical computer and a trial function may be computed based on the expectation values.

Based on the trial function values for the variational parameters of the one or more initialization quantum circuit may be determined. The values for the variational parameters may be optimized by fitting the trial function to desired function. The optimized initialization values may then used to initialize the one or more variational quantum circuits of the quantum circuit.

Thereafter, the variational parameters of the quantum circuit may be variationally optimized until the output of the quantum computer convergence towards a solution of the question.

The above-referred initialization method may be used in quantum learning methods that are executed on a hybrid computer system comprising a classical computer system and a quantum computer as for example described with reference to FIG. 1A of this disclosure.

Hence, in a further aspect, the invention may relate to a quantum learning method based on a quantum circuit, wherein the quantum circuit may include a plurality of different quantum sub-circuits, including one or more quantum feature circuits, each quantum feature circuit being configured to map a variable of the differential equation to a Hilbert space that is associated with the qubits of the quantum computer and one or more variational quantum circuits associated with one or more variational parameters for training the quantum circuit to approximate a solution. The method may include initializing the at least part of the variational parameters of the one or more variational quantum circuits based on initialization values that are classically computed based on a classically simulable version of the quantum circuit that are simulated on a classical computer; and, variationally optimizing the quantum circuit based on the variational parameters until a predetermined convergence of the output of the quantum circuit with the solution is determined. The invention may also relate to a system that is configured to execute such quantum learning method.

In a further aspect, the invention may relate to a system for solving a set of (non)linear differential equations, DEs, using a hybrid data processing system comprising a classical computer system and a quantum computer system: the system comprising: a memory device including computer-executable instructions and a processor connected to the memory device, the processor being configured to perform executable operations comprising: instructing the classical computer system to receive or determine a formulation of quantum circuits representing the set of DEs, the quantum circuits being parameterized by variables x of the DEs and including one or more function circuits for determining one or more trial functions values f(xj) around one more points xj and one or more derivative function circuits for determining one or more trial derivative values around the one or more points xj; instructing the quantum computer system to execute the quantum circuits for a set of points xj in the variable space x of the DEs; instructing the classical computer system, in response to the execution of the quantum circuits quantum, to determine hardware measurement data; and, instructing the classical computer system to determine on the basis of the quantum hardware measurement data and a loss function, if the quantum hardware measurement data forms a solution to the set of (non)linear DEs.

The invention may also relate to a computer program or suite of computer programs comprising at least one software code portion or a computer program product storing at least one software code portion, the software code portion, when run on a computer system, being configured for executing any of the method steps described above.

The invention may further relate to a non-transitory computer-readable storage medium storing at least one software code portion, the software code portion, when executed or processed by a computer, is configured to perform any of the method steps as described above.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIGS. 1A and 1B depict a network of data processing system and an optimization scheme for solving nonlinear DEs according to an embodiment of the invention;

FIGS. 2A and 2B depicts differentiable quantum circuits DQC according to various embodiments of the invention;

FIG. 3A-3C depict quantum circuits according various embodiments of the invention;

FIGS. 4A and 4B illustrate exemplary variational quantum circuits according to various embodiments of the invention;

FIG. 5 schematically depicts a flow diagram of a method for solving (non-) linear DEs using quantum computation according to an embodiment of the invention;

FIG. 6A-6B depict a method for solving general (non-)linear DEs using quantum computation according to an embodiment of the invention.

FIG. 7. is a hardware-level schematic illustrating the application of logical operations to qubits using a quantum circuit;

FIG. 8 depicts the resultant differential quantum circuit-computed solutions using three different feature maps;

FIG. 9 depicts the results for a system of strongly coupled equations;

FIG. 10 depicts a schematic of a flow through a convergent-divergent nozzle and numerical results obtained by standard classical solvers;

FIG. 11 shows a DQC solution for the Navier-Stokes differential equation problem;

FIG. 12 depicts a quantum circuit for a post-NISQ DQC-based scheme according to an embodiment of the invention.

FIG. 13A-13C illustrate different types of differential equations that can be solved using the embodiments in this applications.

FIG. 14 shows a generalized parametrized quantum circuit architecture with generalized Feature Map and Variational Circuit layouts, combined with initialization subcircuits.

FIG. 15 shows a workflow/strategy for initializing the variational parameters of the circuit based on a classical pre-processing/fitting step.

FIG. 16 shows an example classical-initialization to illustrate a specific case of the workflow from FIG. 15

FIG. 17 shows an example equation solving where the equation is parametrized with a library of functionals, illustrating the workflow and showcasing a concrete result explaining the steps underlying case FIG. 13C

### DETAILED DESCRIPTION

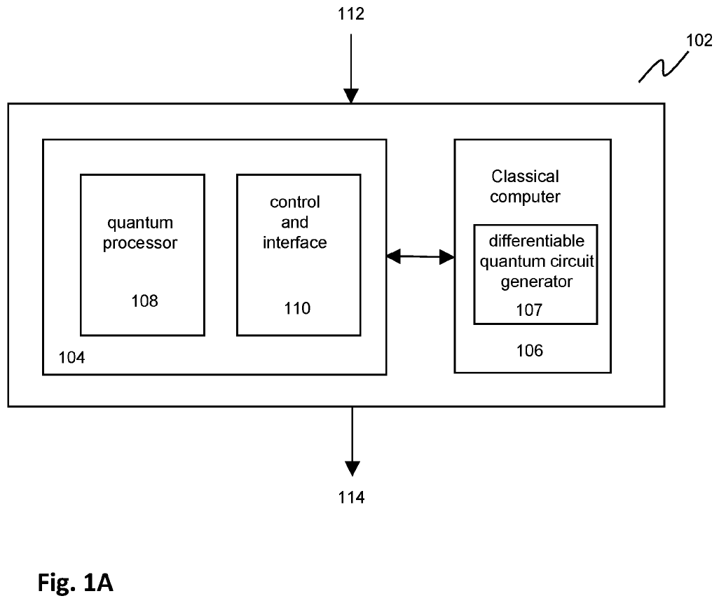

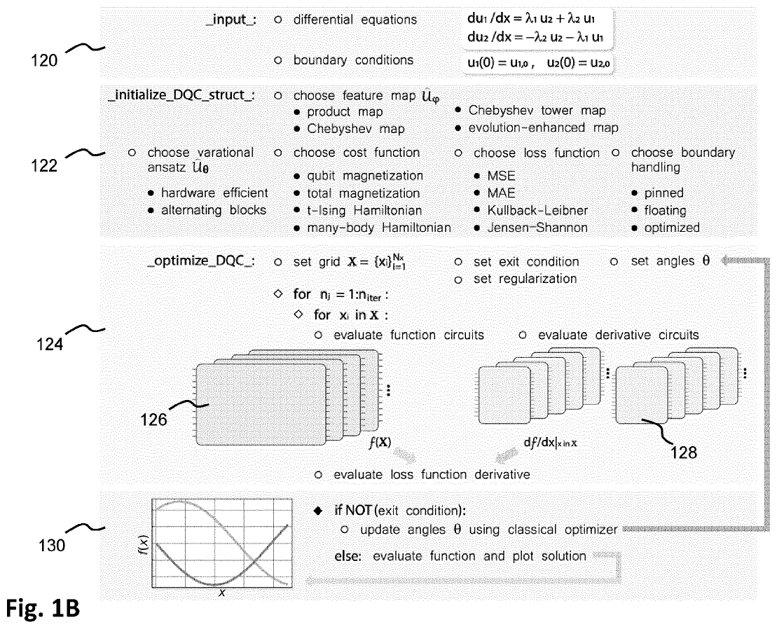

FIGS. 1A and 1B depict a data processing system and an optimization scheme for solving nonlinear differential equations according to an embodiment of the invention. In particular, FIG. 1A depicts a system 102 including a first data processing system connected to a second data processing system 106, wherein the first data processor system may be implemented as a quantum computer system 104 comprising a quantum processor system 108, comprising quantum processing elements e.g. gate-based qubits, and a controller system 110 comprising input output (I/O) devices which form an interface between the quantum processor and a second data processor, e.g. a classical computer 106 comprising one or more classical processors. The controller system may include a system for generating control signals for controlling the quantum processing elements. The control signals may include for example a sequence of pulses, e.g. microwave pulses, voltage pulses and/or optical pulses, which are used to manipulate qubits. Further, the controller may include output device, e.g. readout circuits, for readout of the qubits and the control signals for readout of the quantum processing elements, e.g. a readout pulse for reading a qubit. In some embodiments, at least a part such readout circuit may be located or integrated with the chip that includes the qubits.

The system may further comprise a (purely classical information) input 112 and an (purely classical information) output 114. The data processor systems may be configured to solve nonlinear differential equations using the quantum computer. Input data may include information related to the differential problem to be solved. This information may include the differential equations, boundary conditions, information for construction quantum circuits that can be executed on the quantum computer and information about an optimization process that needs to be executed to compute the solutions to the nonlinear differential equations. The input data may be used by the system to construct quantum circuits, in particular differentiable quantum circuit, and to classically calculate values, e.g. sequences of pulses, which may be used to initialize and control qubit operations according to the quantum circuit. To that end, the classical computer may include a differentiable quantum circuit (DQC) generator 107. Similarly, output data may include ground state and/or excited state energies of the quantum system, correlator operator expectation values, optimization convergence results, optimized quantum circuit parameters and hyperparameters, and other classical data.

Each of the one or more quantum processors may comprise a set of controllable quantum processing elements, e.g. a set of controllable two-level systems referred to as qubits. The two levels are |0 [symbol] and |1 [symbol] and the wave function of a N-qubit quantum processor may be regarded as a superposition of 2^{N} of these basis states. The embodiments in this application however are not limited to qubits but may include any multi-level quantum processing elements, e.g. qutrits, that is suitable for performing quantum computation Examples of such quantum processors include noisy intermediate-scale quantum (NISQ) computing devices and fault tolerant quantum computing (FTQC) devices.

The quantum processor may be configured to execute a quantum algorithm in accordance with the gate operations of a quantum circuit. The quantum processor may be implemented as a gate-based qubit quantum device, which allows initialization of the qubits into an initial state, interactions between the qubits by sequentially applying quantum gates between different qubits and subsequent measurement of the qubits' states. To that end, the input devices may be configured to configure the quantum processor in an initial state and to control gates that realize interactions between the qubits. Similarly, the output devices may include readout circuitry for readout of the qubits which may be used to determine a measure of the energy associated with the expectation value of the Hamiltonian of the system taken over the prepared state.

In some embodiments, the first data processor system may be implemented as a software program for simulating a quantum computer system 104 comprising a quantum processor system 108. Hence, in that case, the software program may be a classical software program that runs a classical computer 106 so that quantum algorithms can be developed, executed and tested on a classical computer without requiring access to a hardware implementation of the quantum processor system.

The embodiments in this application aim to solve nonlinear differential equations of a general form using a quantum computer in a way that is substantially different from the schemes known in the prior art. For a given set of nonlinear differential equations, quantum circuits are constructed on the basis of so-called differentiable quantum circuits (DQCs). These quantum circuits may be executed on the quantum computer and a cost function, e.g. an Hermitian operator such as a Hamiltonian, may be used to measured observables that form an approximation of the solution to the set of nonlinear differential equations are used in a classical optimization algorithm. A loss function may be used to determine if the approximation of the solution is sufficiently close to the solution to the set of nonlinear differential equations.

An exemplary workflow of the optimization loop is provided in FIG. 1B, showing an input step 120 for receiving information about the differential problem, e.g. a set of differential equations and boundary conditions. Thereafter, an optimization scheme may be initialized 122, wherein a quantum circuit may be constructed based on differentiable quantum circuits, wherein quantum circuits may represent a function and derivative functions circuits. The construction of the quantum circuit may include selection of a quantum feature map circuits, a variational ansatz circuits which can be adjusted by an optimization parameter θ, a cost function and a loss function that can be used to exit the optimization loop.

Thereafter, the optimization scheme may be started by determining approximate solutions for the set of differential equations at a set of points xⱼ. To that end, for each point xⱼ the quantum circuit is executed on the quantum computer. As shown in the figure, the quantum circuit may include function circuits 126 and derivative function circuits 128. A function circuit may be used to evaluate a function ƒ around point xⱼ and a derivative function circuit may be used to evaluate the derivative of the function dƒ/dx around point xⱼ. The execution of each quantum circuit will result in a measured value, an observable of the quantum state of the quantum computer, representing an approximation of a function value or a derivative value at a particular point xⱼ. Then, the loss function and the measured values may be used to determine if the measured values form a sufficient accurate approximation of the solution to the set of differential equations. If this is not the case, in a further step 130, a classical optimization scheme may be used to update the optimization parameter θ of the variational ansatz circuit. Thereafter, approximate solutions are determined for each xⱼ by executing the quantum circuits based on updated the optimization parameter θ.

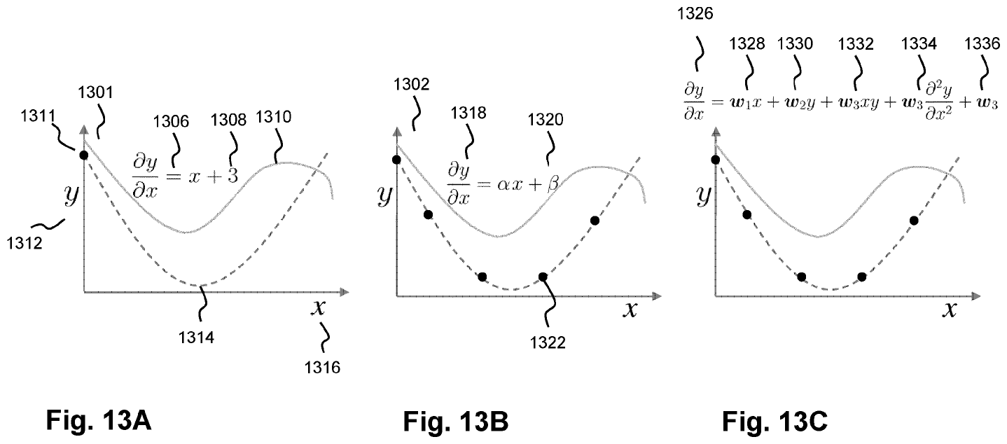

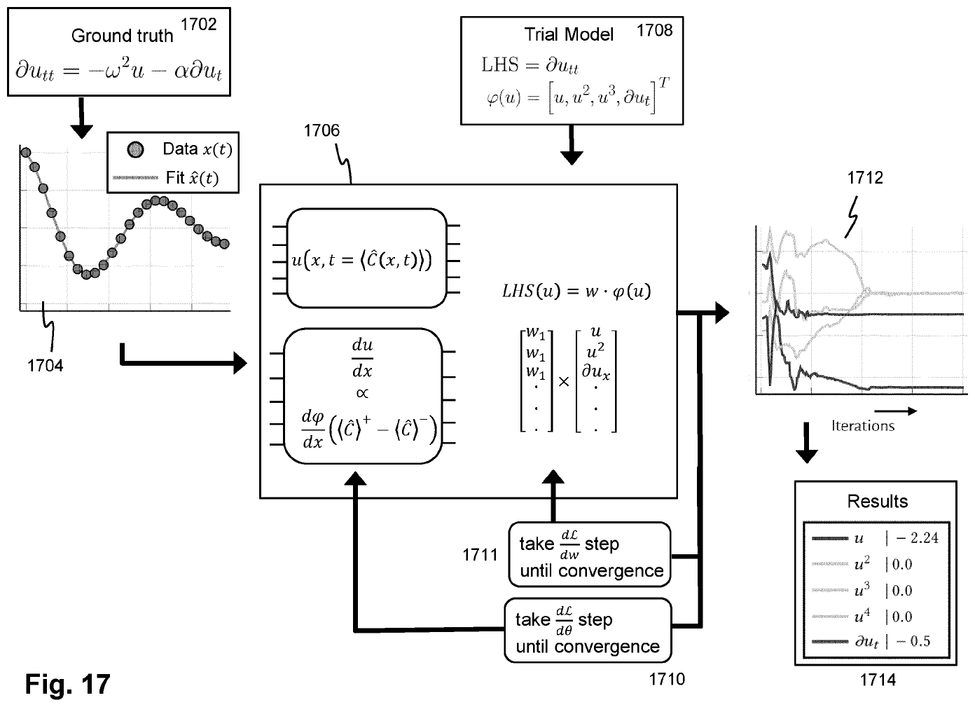

It is submitted that the differential equations described with reference to the scheme of FIG. 1B only illustrate a few examples of the many different types of differential equations that can be solved on the basis of this scheme. Examples of such differential equations can be found throughout this application and may include parameterized differential equations. For example, in an embodiment, a parameterized differential equation may comprise one or more of the elements in the equation which are (hyper)parameters (alpha/beta) rather than functions (ƒ(x), g(x,y)) or dependent/dimensional variables (x,y,z,t). In another embodiment, a parameterized differential equation may be based on a parameterized linear combination of functionals. Examples of such differential equations. are described with reference to FIGS. 13A-13C and FIG. 17.

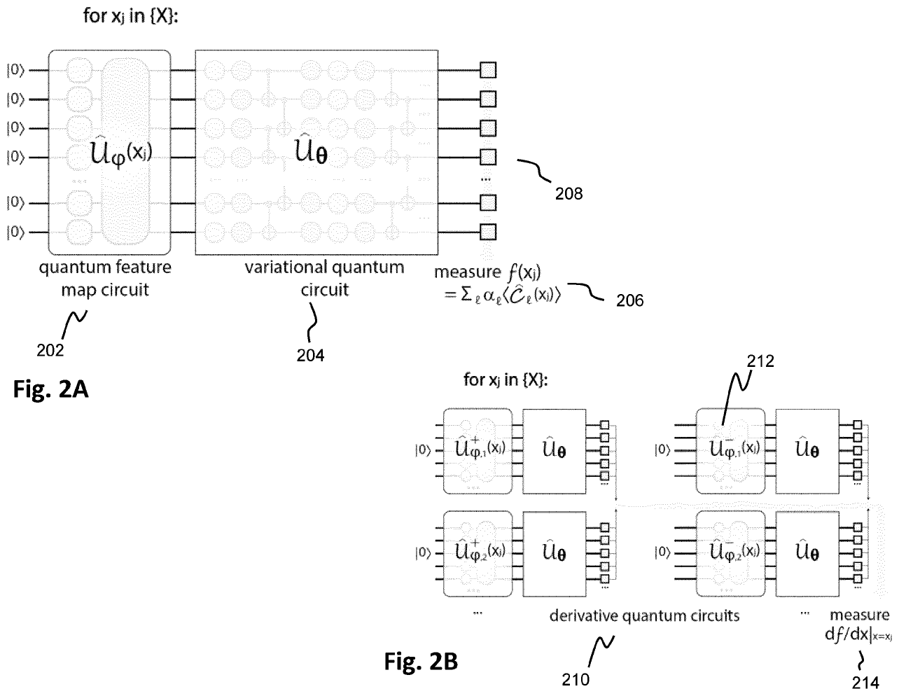

FIGS. 2A and 2B depicts differentiable quantum circuits according to various embodiments of the invention. In particular, the circuit in FIG. 2A comprises feature map circuit 202, a variational quantum circuit 204 followed by a readout 208. A quantum feature map is configured to encode data in a quantum register, e.g. a classical variable x is transformed into a set of phases of rotations. The quantum feature map circuit actuates a unitary evolution Û_{φ} over the qubits of the quantum computer, wherein the unitary evolution is a function of differential equation parameter x, as well as variational ansatz Û_{θ} 204, and an observable-based readout 208 for the set of operators [symbol] comprising the cost function Hamiltonian: ƒ(xⱼ)= [symbol] (xⱼ) [symbol] . Combining measurements 206, a trial function ƒ(xⱼ) may be computed as a potential solution to the differential equation.

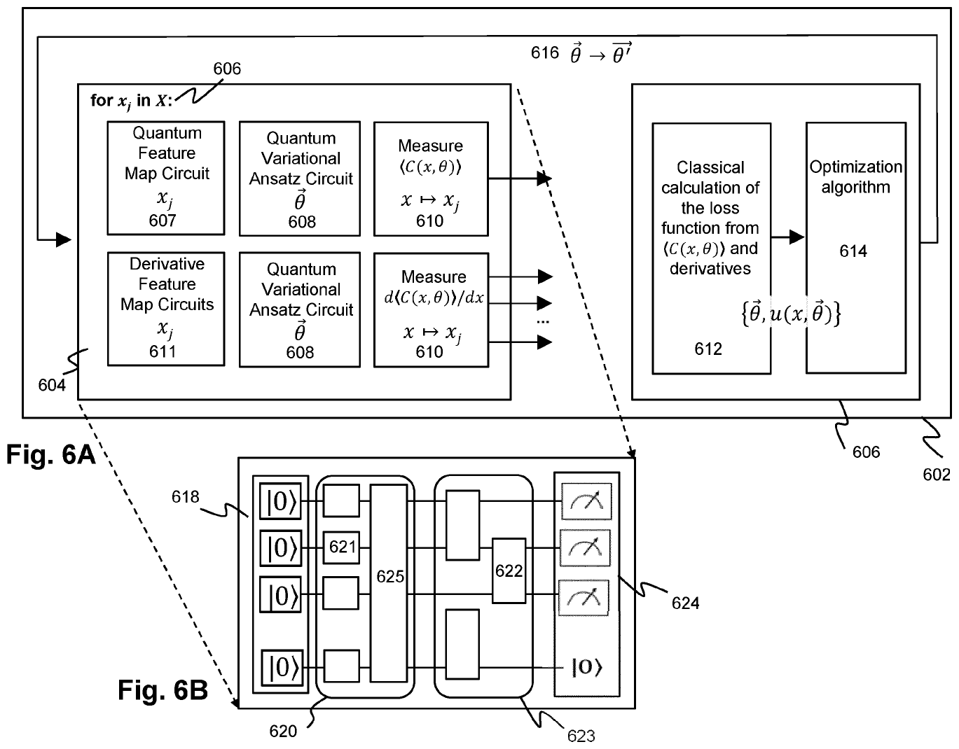

Thus, the quantum circuit used for encoding the value of the function at specific value of the variable x=xⱼ, comprises a feature map Û_{φ} that encodes the x-dependence into the quantum computer, followed by variational ansatz Û_{θ}, and observable-based readout for the set of operators [symbol] . The measurement result is classically post-processed to provide a quantum function representation ƒ(x) as a sum of expectations, where coefficients αₗ can be optimized in a quantum-classical hybrid loop as e.g. described with reference to FIGS. 6A and 6B. To compose the loss function circuit, measurements for different points of optimization grid {X} are required.

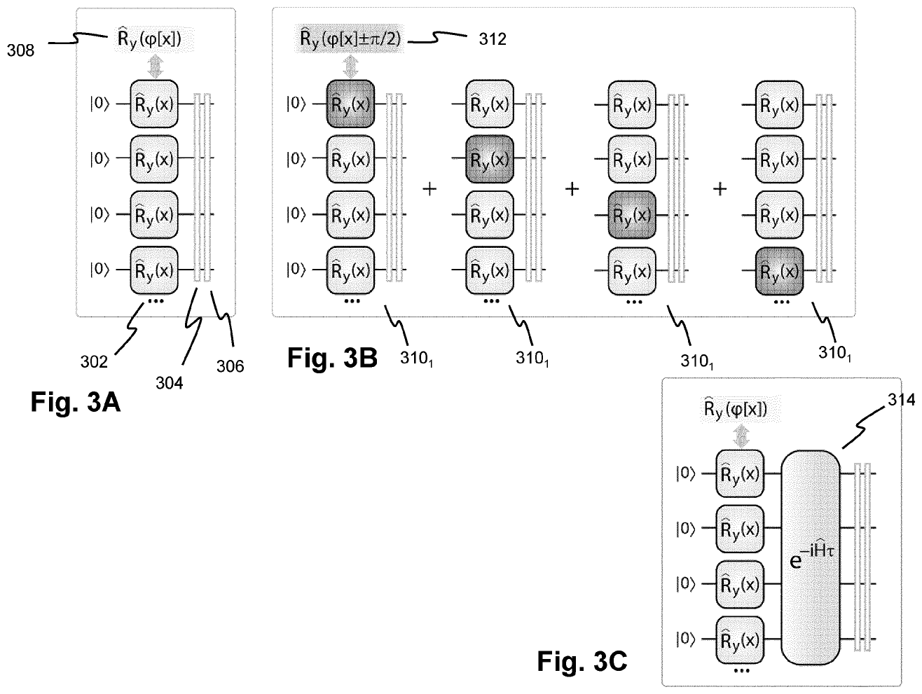

FIG. 2B depicts a similar structure as illustrated in FIG. 2A, but instead is used to compute the derivative of the function ƒ with respect to x 214, using derivative quantum circuits 210, and evaluated at x=xⱼ. A particular difference with the circuits depicted in FIG. 2A is the parametric shift of variables in unitary 212. The derivative of the sought function ƒ(x) evaluated at specific point x=xⱼ may be estimated as a sum of expectations for derivative quantum circuits. The full structure follows from the differentiation of the feature map circuit as e.g. described with reference to FIG. 3. The measurement results of the function and derivate measurements may be classically post-processed, and combined for all j in xⱼ from x. Further, variational coefficients θ and cost structure coefficients α may be optimized in a quantum-classical hybrid loop in order to reduce the loss function value for θ and α settings as described with reference to FIG. 6.

Thus, as can be seen from FIG. 2, trial functions may be prepared as quantum circuits parametrized by variables x∈ [symbol] (or a collection of variables) of the differential equations as shown in FIG. 2. As the discussion is generalized straightforwardly to the case of v variables, x∈ [symbol] ^{v}, for brevity the simplified single variable notation x is used. Using quantum feature map encoding Û_{φ}(x), a pre-defined nonlinear function of variables φ(x) is cast to amplitudes of the quantum state Û_{φ}(x)|Ø [symbol] prepared from some initial state |Ø [symbol] . Using quantum feature map encoding Û_{φ}(x), a pre-defined nonlinear function of variables φ(x) is cast to amplitudes of the quantum state Û_{φ}(x)|Ø [symbol] prepared from some initial state |Ø [symbol] .

A quantum feature map represents a latent space encoding, that unlike amplitude encoding, does not require access to each amplitude and is controlled by classical gate parameters. The quantum feature maps real parameter x to the corresponding variable value. Next, a variational quantum circuit Û_{θ} parametrized by vector θ that can be adjusted in a quantum-classical optimization loop is used. The resulting state |ƒ_{φ,θ}(x) [symbol] =Û_{θ}Û_{φ}(x)|Ø [symbol] for optimal angles contains the x-dependent amplitudes sculptured to represent the sought function. Finally, the real valued function can be read out as an expectation value of predefined Hermitian cost operator Ĉ, such that the function reads:

ƒ(x)= [symbol] ƒ_{φ,θ}(x)|Ĉ|ƒ_{φ,θ}(x) [symbol] (1)

The optimization process based on the variational circuit parameter θ and the loss function may be regarded as a quantum machine learning process wherein the quantum circuit comprising the variational quantum circuit may define a plurality of mutually interacting qubits that can be adjusted variationally by (at least on) variational circuit parameter θ. This way, the plurality of mutually interacting qubits may define a parametrized quantum circuit that can be trained based on variational circuit parameter θ, training data and a loss function to approximate a function ƒ(x) for a certain value of variable x.

The differentiation of quantum feature map circuits may be defined by the following expression: dÛ_{φ}(x)/dx=ΣⱼÛ_{dφ,j}(x), which allows the action differential to be represented as a sum of modified circuits Û_{dφ,j}. This way, function derivatives may be represented using a product derivative rule. Thus, in case of a quantum feature map generated by strings of Pauli matrices or any involutory matrix, the parameter shift rule may be used such that a function derivative may be expressed as a sum of expectations:

$$df ( x ) / dx = \frac{1}{2} {\sum }_{j} ( 〈 {f}_{d φ , j , θ}^{+} ( x ) \vert \hat{C} \vert {f}_{d φ , j , θ}^{+} ( x ) 〉 - 〈 {f}_{d φ , j , θ}^{-} ( x ) \vert \hat{C} \vert {f}_{d φ , j , θ}^{-} ( x ) 〉 ) , \qquad ( 2 )$$

with |uƒ_{dφ,j,θ}^{±}(x) [symbol] defined through the parameter shifting, and index j runs through individual quantum operations used in the feature map encoding. Applying the parameter shift rule once again a second-order derivative d²u(x)/dx² may be obtained with four shifted terms for each generator.

Importantly, to perform quantum circuit differentiation, the automatic differentiation (AD) technique may be used. AD allows to represent exact analytical formula for the function derivative using a set of simple computational rules, as opposed to the numerical differentiation. Since automatic differentiation provides an analytical derivative of the circuit in at any point of variable x, the scheme does not rely on the accumulated error from approximating the derivatives. Notably, all known prior art schemes for quantum ODE solvers involve numerical differentiation using Euler's method and finite difference scheme that suffers from approximation error, and often require fine discretization grid. The embodiments in this application alleviate this problem.

One of the aims of the invention is to define the conditions for the quantum circuit to represent the solution of differential equations, generally written as F[{dⁿƒ/dxⁿ}ₙ, {ƒₘ(x)}ₘ]=0, where the functional F[⋅] is provided by the problem. This demands that derivatives and nonlinear functions need to give net zero contribution. Hence, solving the differential equations may be written as an optimization problem using a loss function [symbol] _{θ}[dₓƒ, ƒ, x]. This corresponds to minimization of F[x]|_{x→x}_{ᵢ}, at the set of points {xᵢ}, additionally ensuring that the boundary conditions are satisfied. Once the optimal angles

$${θ}_{o p t} = {arg min}_{θ} ( {ℒ}_{θ} [ {d}_{x} f , f , x ] ) \qquad ( 3 )$$

are found, the solution from Eq. (1) as a function can be produced. Hence, the embodiments in this application:
1. use quantum feature map encoding to overcome the complexity of amplitude encoding that is used in the prior art for preparing the solution at the boundary;
2. use automatic differentiation of the quantum feature map circuit, allowing to represent analytical function derivatives without imprecision error characteristic to numerical differentiation (finite differencing);
3. use variational quantum circuits to search for a suitable solution in the exponential space of fitting polynomials, thus resembling the spectral and finite element methods with exponentially improved scaling; and,
4. avoid the data readout problem, as the solution is encoded in the observable operator, such that expectation can be routinely calculated.

For the latter point, it differs from amplitude encoding |u [symbol] in HHL and related methods, where getting the full solution from amplitudes is exponentially costly and requires tomographic measurements.

One of the aims of the invention is to construct circuits that can work for quantum processors with limited computational power, meaning with the gate depth (number of operations to performed in series) being limited to a certain limited amount. The gate depth largely defines the training procedure, which is relied upon in the classical optimization loop. Alleviating the reduced depth problem, it is also possible to exploit parallel training strategies for the quantum circuit and quantum state encoding, coming closer to the ideal quantum operation regime.

Below quantum circuits are described that may be used to build differentiable circuit as a solution of differential equations. The quantum circuits include quantum feature maps and their derivatives; variational quantum circuits (ansatz); cost functions that define trial functions; and loss functions that are used in the optimization loop. Additionally, boundary handling techniques, regularization schemes, and a complete optimization schedule are described.

A quantum feature map is a unitary circuit Û_{φ}(x) that is parametrized by the variable x and typically nonlinear function φ(x). Acting on the state, it realizes a map x [symbol] Û_{φ}(x)|Ø [symbol] s.t. the x-dependence is translated into quantum state amplitudes. This is also referred as a latent space mapping. Different ways of feature map encoding exist. Below various examples are described including a Chebyshev quantum feature map that allows to approximate highly nonlinear functions. The procedure of feature map differentiation, as an important step in constructing quantum circuits for solutions of differential equations is also described.

In a first embodiment, a product feature map may be used that uses qubit rotations.

FIG. 3A-3C depict quantum circuits according various embodiments of the invention. In particular, FIG. 3A shows the basic form of a quantum feature map, which is here illustrated as an example of a ‘product’ type feature map, wherein single qubit rotations (here chosen as \hat{R}_{y}(φ[x])) act on each qubit individually and are parametrized by a function of variable x. Such operation may be referred to as a layer of rotation operations. Reading from left to right going forward in time, the rest of the circuit is schematically summarized, including the application of variational ansatz 304 and a cost function measurement 306 as described in more detail with reference to FIG. 6. For the nonlinear feature map encoding, the nonlinear function φ(x) may be used as an angle of rotation. The product feature map can be further generalized to several product layers, and different functions {φ}. For example, several feature maps may be concatenated to represent a multivariable function.

FIG. 3B illustrates an example of a derivative quantum circuit for the product feature map of FIG. 3A. Differentiation over variable x follows the chain rule of differentiation, including qubit operations 312 with shifted phases \hat{R}_{y}(φ[x]±π/2). Here, the expectation value of the derivative is written as a sum of separate expectations with shifted phases, repeated for each x-dependent rotation 310₁₋₄.

FIG. 3C depicts an example of a generalized product feature map, where the layer of rotation follows by the unitary evolution generated by Hamiltonian Ĥ 314. For complicated multiqubit Hamiltonians, the encoded state may comprise exponentially many unique x-dependent amplitudes. The time interval T can be set variationally, or annealed from zero to a finite value during the optimization procedure.

Preferably, the product feature map has nonlinear dependence on the encoded variable X. In the simplest case, this may correspond to a single layer of rotations. Such product feature map may be described by the following expression:

$${φ}_{} ( x ) = {{⊗}_{j = 1}}^{{N}^{′}} {\hat{R}}_{α , j} ( φ [ x ] ) , \qquad ( 4 )$$

where N′≤N is a number of qubits that is used by the quantum computer for the encoding. Further,

$${\hat{R}}_{α , j} ( φ ) = exp ( - i \frac{φ}{2} {\hat{P}}_{α , j} )$$

is a Pauli rotation operator for Pauli matrices \hat{P}_{α,j}=\hat{X}ⱼ, Ŷⱼ or \hat{Z}ⱼ, (α=x,y,z, respectively) acting at qubit j for phase φ. As we consider rotations on different j here the symbol ⊗ⱼ denotes the tensor product. This type of feature map circuit is also used in Quantum Circuit Learning. The next step is to assign a nonlinear function for rotation. In an embodiment, the nonlinear function may be selected as φ(x)=arcsin x and α=y such that only real amplitudes are generated. The unitary operator of Eq. (5) may then rewritten as:

$${φ}_{} ( x ) = {{⊗}_{j = 1}}^{N} exp ( - i \frac{arc sin x}{2} {\hat{Y}}_{j} ) , \qquad ( 5 )$$

leading to amplitudes that depend on the encoded variables as cos[(arcsin x)/2] and sin[(arcsin x)/2]. Acting on the initial state |Ø [symbol] this feature map may encode the variable as an N-th degree polynomial formed by {1, x, \sqrt{1−x²}} and products [QCL]. The redundancy from many qubits thus forms a basis set for function fitting [S-S]. % We note that while basis set can be continuously improved adding more rotations, this choice of basis is well-suitable for linear and quadratic functions, but often lacks the expressive power.

The product feature map can be generalized to several layers of rotations [symbol] =1, 2, . . . , L, various nonlinear functions [symbol] and specific subsets of qubits N written as:

$${φ}_{} ( x ) = {\prod }_{ℓ = 1}^{L} {⊗}_{j ∈ {N}_{ℓ}} {\hat{R}}_{α , j}^{( ℓ )} ( {φ}_{ℓ} [ x ] ) . \qquad ( 6 )$$

Below an example of how the quantum feature map can be differentiated is provided, e.g. the example in Eq. (4) wherein α=y rotations and full layer are considered. The derivative for the unitary operator generated by any involutory matrix (length-1 Pauli string in this case) can be written as:

$$\frac{d}{dx} {φ}_{} ( x ) = \frac{1}{2} ( \frac{d}{dx} φ ( x ) ) {\sum }_{{j}^{′} = 1}^{N} {{⊗}_{j = 1}}^{N} ( - i {\hat{Y}}_{{j}^{′}} {δ}_{j , {j}^{′}} ) {\hat{R}}_{y , j} ( φ [ x ] ) = \frac{1}{2} ( \frac{d}{dx} φ ( x ) ) {\sum }_{{j}^{′} = 1}^{N} {{⊗}_{j = 1}}^{N} {\hat{R}}_{y , j} ( φ [ x ] + {πδ}_{j , {j}^{′}} ) , \qquad ( 7 )$$

where Euler's formula can be used to rewrite the derivative into the form of a sum of unitaries, where x-dependent rotations are shifted one-by-one. Next, the formula may be generalized to the expectation value of any observable [symbol] Ĉ [symbol] for the encoded state, following the step of standard parameter shift rule. This reads:

$$\frac{d}{dx} 〈 ∅ \vert {φ}_{} {( x )}^{†} \hat{C} {φ}_{} ( x ) \vert ∅ 〉 = \frac{1}{4} ( \frac{d}{dx} φ ( x ) ) ( {〈 \hat{C} 〉}^{+} - {〈 \hat{C} 〉}^{-} ) \qquad ( 8 )$$

where [symbol] ⁺ and [symbol] ⁻ are the sum of shifted unitaries:

$${〈 \hat{C} 〉}^{\pm } = {\sum }_{{j}^{′} = 1}^{N} {{⊗}_{j = 1}}^{N} {\hat{R}}_{y , j} ( φ [ x ] \pm \frac{π}{2} {δ}_{j , {j}^{′}} ) \hat{C} {\hat{R}}_{y , j} ( φ [ x ] \pm \frac{π}{2} {δ}_{j , {j}^{′}} ) . \qquad ( 9 )$$

The corresponding derivative quantum circuits (DQC) are shown in FIG. 3B, where differentiation of the cost function for feature map is performed using the chain rule (highlighted rotations). A similar strategy can be applied for generic multilayer feature maps and a different choice of nonlinear map φ(x). Finally, in the cases where the generator of the feature map (encoding Hamiltonian Ĥ) is not an involutory matrix, they may be rewritten as a sum of unitary operators, and measure the derivative as a sum of overlap using the SWAP test.

In another embodiment, a nonlinear quantum feature map may be used which may be referred to as the Chebyshev feature map. Belonging to the product feature map family, this feature map drastically changes the basis set for function representation. As a building block a single qubit rotation \hat{R}_{y,j}(φ[x]) may be used, but with nonlinearity introduced as φ(x)=2n arccos x, n=0, 1, 2, . . . , such that the encoding circuit reads:

$${φ}_{} ( x ) = {{⊗}_{j = 1}}^{N} {\hat{R}}_{y , j} ( 2 n [ j ] arccos x ) . \qquad ( 10 )$$

Here it is considered that the coefficient n[j] may in general depend on the qubit position. The seemingly small change of factor two multiplication goes a surprisingly long way. Namely, let us expand the rotation using Euler's formula, getting:

$${\hat{R}}_{y , j} ( φ [ x ] ) = exp ( - i \frac{2 n arccos ( x )}{2} {\hat{Y}}_{j} ) = cos ( n arccos ( x ) ) {j}_{} - i sin ( n arccos ( x ) ) {\hat{Y}}_{j} = {T}_{n} ( x ) {j}_{} + {U}_{n} ( x ) {\hat{X}}_{j} {\hat{Z}}_{j} . \qquad ( 11 )$$

The resulting decomposition of equation (11) corresponds to the unitary operation with matrix elements defined through degree—n Chebyshev polynomials of first and second kind, denoted as Tₙ(x) and Uₙ(x). Formally, Chebyshev polynomials represent a solution of Chebyshev differential equation:

$$( 1 - {x}^{2} ) \frac{{d}^{2} y}{{dx}^{2}} - x \frac{dy}{dx} + {n}^{2} y = 0 , n = 0 , 1 , 2 , 3 ... \qquad ( 12 )$$

$$wherein$$

$$\begin{matrix}y ( x ) = A cos ( n arccos ( x ) ) + B sin ( n arccos ( x ) ) \\ ≡ {AT}_{n} ( x ) + {BU}_{n} ( x ) , \vert x \vert < 1 ,\end{matrix} \qquad ( 13 )$$

and wherein A, B are some constants. Chebyshev polynomial of the first kind for low degrees can be written explicitly as T₀(x)=1, T₁(x)=x, T₂(x)=2x²−1, T₃(x)=4x³−3x, and higher degrees can be deduced using the recursion relation

Tₙ₊₁(x)=2xTₙ(x)−Tₙ₋₁(x). (14)

Similarly, second-kind Chebyshev polynomials can be written as U₀(x)=1, U₁(x)=2x, Uₙ₊₁(x)=2x, and Uₙ(x)−Uₙ₋₁(x). The crucial properties of Chebyshev polynomials are their chaining properties, nesting properties, and simple differentiation rules. The chaining properties for polynomials of the first and second kind read as 2Tₘ(x)Tₙ(x)=Tₘ₊ₙ(x)+T_{|m-n|}(x) and Uₘ(x)Uₙ(x)=Σₖ₌₀ⁿUₘ₋ₙ₊₂ₖ(x), respectively. Derivatives can be obtained as dTₙ(x)/dx=nUₙ₋₁(x). Nesting corresponds to the relation Tₙ(Tₘ(x))≡Tₙₘ(x). Finally, polynomials of different kinds can be converted as Uₙ(x)=2ΣⱼⁿTⱼ(x) when j is even, and Uₙ(x)=2Σⱼⁿ [Tⱼ(x)−1] when j is odd. Finally, it is noted that Chebyshev polynomials may represent oscillating functions when defined in the x=(−1,1) region, and their derivatives diverge at the boundaries of this interval.

The power of the representation described can be inferred from the approximation theory. It states that any smooth function can be approximated as ƒ(x)=Σₙ₌₀^{∞}AₙTₙ(x), |x|≤1. Chebyshev polynomials form an optimal set of basis function in the sense of the uniform L_{∞} norm. This is why they are at the foundation of spectral algorithms for solving ODEs, and also give an edge in quantum simulation.

In examples described below, two types of Chebyshev quantum feature maps are considered. The first version corresponds to a sparse Chebyshev feature map defined as:

$${φ}_{} ( x ) = {{⊗}_{j = 1}}^{N} {\hat{R}}_{y , j} ( 2 arccos x ) , \qquad ( 15 )$$

where encoded degree is homogeneous and is equal to one. Here the chaining properties Tₙ (x) and Uₙ (x) should be remembered, noting that once states with Chebyshev polynomials as pre-factors are created, the basis set will grow further by concatenating elements. In the following, the sparse distinction is dropped and simply refer to Eq. (15) as Chebyshev feature map. The second version corresponds to a Chebyshev tower feature map, which may be defined as:

$${φ}_{} ( x ) = {{⊗}_{j = 1}}^{N} {\hat{R}}_{y , j} ( 2 j arccos x ) , \qquad ( 16 )$$

where the encoded degree grows with the number of qubit, creating a tower-like structure of polynomials with increasing n=j. Again, as polynomials chain together and morph between two kinds and their degrees, the basis set is largely enriched. This is the choice that is exploited when large expressibility is needed without increasing system size and number of rotations. Eq. (16) allows the representation of generic functions, and can be improved further by using layers of rotations as in Eq. (6).

Product feature maps may induce nonlinear mappings between variable(s) x and quantum states described by tensor products of separate single-qubit wavefunctions. These states are limited to the subspace of product states. To utilize the power of the entire Hilbert space of the system, approaching the amplitude encoding case, independently distinct amplitudes need to be populated, including the subspace of entangled states. To make the described feature maps even more expressive, it is suggested to enhance the product feature maps (and specifically the layered Chebyshev map) with additional entangling layers represented by Hamiltonian evolution. Namely, after the set of single qubit rotations another unitary exp(−iĤτ) may be considered which acts for time τ and is generated by the Hamiltonian Ĥ. The sketch of the circuit is shown in FIG. 3C. By choosing Ĥ as a complex many-body Hamiltonian, it is ensured that exponentially many amplitudes are generated. It is known that the quantum simulation of dynamics leads to a volume-like increase of entanglement.

One important choice is when Ĥ corresponds to a hard problem from NP-hard complexity class, as proposed. Then using two layers of rotations plus evolution the embedding becomes difficult to simulate classically, but can be implemented as unitary evolution on a quantum computer. The evolution-enhanced feature map can also be seen through the prism of a recently proposed Fourier feature maps, which are a class of quantum feature maps based on the evolution exp (−iĤ_{data,J}x), which is applied for qubits in J. The Fourier map allows functions to be encoded as Fourier series defined by the differences of the eigenvalues of Ĥ_{data}. The evolution-enhanced feature map then joins the Chebyshev and Fourier basis sets, encoded in the full Hilbert space for complex Ĥ.

In another embodiment, a variable may be encoded the data using a feature map by transforming it into the canonical amplitude encoding form. This relates x, written in binary form, to a computational basis state in binary representation. The corresponding feature map Û_{φ}(x) to encode the binary variable x reads

$${\hat{U}}_{φ} ( x ) = {⊗}_{j = 1}^{N} exp ( - i \frac{π}{2} {x}_{j} {\hat{X}}_{J} ) ,$$

where {xⱼ} denote binary values for the parameter x in j-th digit. The differentiation of the amplitude-encoding feature map then relies on the product rule for N rotations, and also includes the binary derivative of the variable from the product rule.

In a further embodiment, a variable may be converted into the decimal representation as xᵢₙₜ=Σⱼxⱼ·2^{j}. For the reverse procedure, each binary digit xⱼ can be identified by the remainder of the repeated division xⱼ=mod(xᵢₙₜ, 2^{j}). Û_{φ}(x) thus can be rewritten as a function of xᵢₙₜ, and learn how to differentiate circuits with this feature map with respect to x=xᵢₙₜ.

Amplitude-encoding feature maps offer a powerful technique when dealing with functions of discrete variables and functions encoded as quantum wavefunctions (rather than expectation value). They can give an advantage in terms of compressing data to a quantum register.

To construct the solution of the differential equation as a quantum circuit we need to manipulate the latent space basis function and bring both derivatives and function to the required form. This is achieved through the variational circuit Û_{θ}, typically referred to as a quantum ansatz. Below various detailed architectures are described.

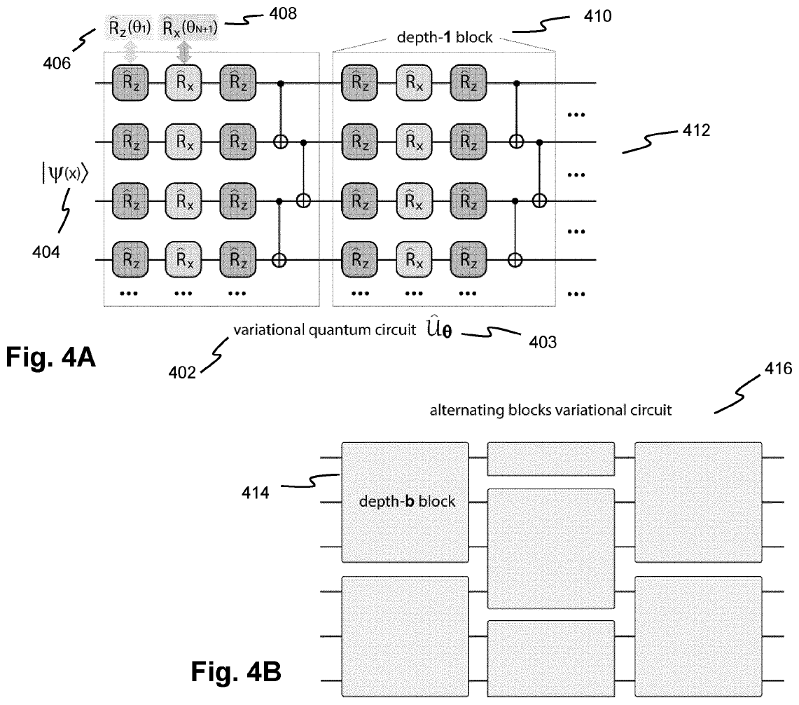

In an embodiment, a variational circuit Û_{θ} one or more layers of parametrized rotations may be selected. These layers may be followed by layers of CNOT operations. This is known as a hardware efficient ansatz (HEA), which was proposed for variational quantum encoder VQE schemes for chemistry applications. The structure of a HEA quantum circuit corresponds to concatenated layers of single qubit rotations and global entangling layers for all N qubits or at least a large part thereof FIGS. 4A and 4B illustrate exemplary variational quantum circuits according to various embodiments of the invention. In particular, FIG. 4A shows a variational ansatz 402 in the so-called hardware-efficient form. It includes parametrized rotation layers forming an \hat{R}_{z}−\hat{R}ₓ−\hat{R}_{z} pattern, such that arbitrary single qubit rotations can be implemented. Variational angles θ are set for each rotation individually 406, 408. The rotation layer is applied to a qubit initial state |ψ(x) [symbol] 404 coming from the preceding quantum circuit, the feature map circuit. The variational rotations may be followed by one or more entangling layers, which may include controlled NOT (CNOT) operations between nearest-neighboring qubits. The blocks 710 of “rotations-plus-entangler” are repeated d times 412 to form a full variational circuit Û_{θ} 403.

FIG. 4B shows a more general form of alternating blocks ansatz 416, incorporating for example the hardware-efficient form circuit from FIG. 4A. The variational circuit may comprise of blocks of width M qubits (M/2 for boundary qubits). Blocks may be chosen in the hardware-efficient form as illustrated with a depth of b. The blocks may be placed in a checkerboard pattern, and repeated n_{b} times. The goal of this alternating-blocks strategy is to entangle qubits locally, while avoiding global entangling operations that would normally often result in vanishing gradients during the optimization of θ.

In a further embodiment, an alternating blocks ansatz (ABA) may be used, where instead of global entangling layers separate subblocks are used, interleaved into a checkerboard form as shown in FIG. 4B. Each subblock has a hardware efficient form shown in FIG. 4A for the specified depth b. For the first layer the width of the subblock (number of active qubits) may be equal to M such that [N/M] blocks are used (and is smaller than M if N/M is not an integer). The next layer may comprise (or consist of) the same subblocks, but is shifted by [M/2], where subblocks at the ends are adjusted to span all qubits. The described checkerboard structure may be repeated for d_{layers}. The motivation behind ABA is to entangle qubits locally first, and gradually form a correlated state by interleaving subblocks. Further, global entangling operations that would normally often result in vanishing gradients during the optimization of θ are avoided. This helps to improve trainability of the circuit together while maintaining high expressibility.

It is noted that the choice of ansatz may be sensitive to the choice of cost function operator, as dictated by the symmetry. Namely, as a consequence of cost function choice non-commuting generators [symbol] for the variational ansatz need to be selected such that [ [symbol] ]≠0, where a generator is the rewritten form of a general unitary as Ûⱼ= [symbol] . Here, a generator refers to a quantum operator that acts on one or more of the qubits in a controlled fashion. It is quite a generic concept and cover basically any circuit, gate etc. This ensures that the solution space can be spanned. Also, symmetries may be taken into account, reducing the Hilbert space for the search. In many cases generators can be chosen such that only real amplitudes are generated. An adaptive strategy or a genetic search may also be used.

Further, to search for the optimal circuit parameters, a stochastic gradient descent scheme may be used, and specifically its adaptive version represented by Adam. For this, one or more gradients of the variational circuit ∇_{θ} [symbol] may be measured using the automatic differentiation approach. Choosing an ansatz parametrized by single-qubit rotations allows the application of the parameter shift rule, while overlap measurement opens up options for more general strategies.

To read out information a Hermitian operator may be selected to measure an observable. In general, different choices are available. In an embodiment, a Hermitian operator may comprise the magnetization of a single qubit j, [symbol] \hat{Z}ⱼ [symbol] . This suits functions with range bounded to [−1,1]. In another embodiment, a Hermitian operator comprising the total magnetization of the system Ĉ=Σⱼ\hat{Z}ⱼ (with equal weights) may be selected.

In further embodiments, the cost may be selected as a quantum Hamiltonian that has a provably complex spectrum, and, for instance, belongs to ergodic phase. Such Hermitian operator may comprise an Ising Hamiltonian with additional transverse and longitudinal magnetic fields,

$$\hat{C} = {\sum }_{j} {J}_{j , j + 1} {\hat{Z}}_{j} {\hat{Z}}_{j + 1} + {h}_{j}^{z} {\hat{Z}}_{j} + {h}_{j}^{x} {\hat{X}}_{j} , \qquad ( 17 )$$

where the Ising couplings J_{j,j+1} and hⱼ^{z,x} can be inhomogeneous. For cost functions with several non-commuting groups of observables the Hamiltonian averaging procedure may be used, where term-by-term measurement may be performed. Instead of nearest-neighbour Hamiltonians, in an embodiment, spin-glass type cost functions may be used, which may have the form

$$\hat{C} = {\sum }_{i < j} {J}_{i , j} {\hat{Z}}_{i} {\hat{Z}}_{j} + {\sum }_{j} {h}_{j}^{z} {\hat{Z}}_{j} . \qquad ( 18 )$$

These are known to include NP-hard problem instances, and allows for high expressibility of the circuit describing the DEs solution. Finally, a generic cost function may comprise a large set of Pauli strings, similar to, for instances, in quantum chemistry.

Together with measuring individual cost functions, functions being represented by classically weighted sum of observables may also be considered. Such cost function may have the form

$$\hat{C} = , \qquad ( 19 )$$

where αₗ∈R are weighting coefficients, and Ĉₗ are cost functions that can be chosen from the pool of operators described above. The coefficients may be tunable, such that the gradient descent (represented by Adam in our case) can adjust the cost to have optimal form. This procedure further improves the strength of the hybrid quantum-classical workflow.

To solve the system of differential equation a means needs to be provided that allows to measure (e.g. in terms of a distance) how well the differentiable quantum circuit matches the conditions to be the solution of the problem being considered. The classical optimiser then updates the parameters to reduce this distance. This distance corresponds to the difference between the differential equation and zero evaluated at a set of points, as well as matched initial and boundary conditions. This can be reformulated as an optimization problem for a loss function of derivatives and functions evaluated at the grid of points.

A loss function parametrized by variational angles θ in the following example form may be used

[symbol]

_{θ}[dₓƒ,ƒ,x]= [symbol] _{θ}^{(diff)}[dₓƒ,ƒ,x]+ [symbol] _{θ}^{(boundary)}[ƒ,x], (20)

where the loss contribution from matching the differentials [symbol] _{θ}^{(df)} and the loss contribution from satisfying the boundary conditions [symbol] _{θ}^{(budr)} may be splitted. The differential loss is defined as

$${θ}_{( diff )}^{} [ {d}_{x} f , f , x ] = \frac{1}{M} {\sum }_{i = 1}^{M} L ( F [ {d}_{x} f ( {x}_{i} ) , f ( {x}_{i} ) , {x}_{i} ] , 0 ) \qquad ( 21 )$$

with L (a, b) being a function describing how the distance between the two arguments a and b is being measured. The loss may be estimated on a grid of M points, and is normalized by the grid size. Functional F corresponds to the differential equation written in the form F[dₓu,u,x]=0. It can be evaluated by combining values of ƒ and dₓƒ at the training grid points. The functional includes information about all differential equations when dealing with the system, such that contributions from all equations are accounted for. The boundary loss contribution reads

[symbol]

_{θ}^{(boundary)}[ƒ,x]=ηL(θ(x₀),u₀) (22)

which includes the distance between the function value at the boundary x₀ and given boundary value u₀. It is noted that x₀ can be an initial point or a set of boundary points. A boundary pinning coefficient η may be used to control the weight of the boundary term in the optimization procedure. In particular, larger η>1 may be used to ensure the boundary is prioritized and represented to higher precision.

Different choices of the loss defined by three distance definitions L may be used. In an embodiment, a loss type corresponding to the mean square error (MSE) may be used:

L(a,b)=(a−b)². (23)

While being simple, MSE performs sufficiently well in numerical simulations. In a further embodiment, a mean absolute error (MAE) may also be used as a loss defined with distance L(a, b)=|a−b|.

In further embodiments, several more complex metrics may be used, including the variants of Kullback-Leibler (KL) divergence and Jensen-Shannon divergence. These are well known loss functions that are routinely used in statistical modelling.

The choice of loss functions dictates how the optimizer perceives the distance between vectors and therefore affects the convergence. MSE places a greater emphasis on larger distances and smaller weight on small distances, strongly discouraging terms with large L. Both MAE and KL do not place such an emphasis and may have slower convergence. However, once close to the optimal solution they can achieve higher accuracy than MSE. KL has an additional incentive for keeping the magnitude of the first argument low, which for the differential loss term works well as one want to match the differential equation to zero.

Constructing a quantum circuit that satisfies differential equations, together with matched derivatives it needs to be ensured that an initial value or boundary value problem is solved. Generally this corresponds to setting the function value at the required initial point or the collection of boundary points, thus resembling the quantum circuit learning task [QCL]. At the same time, there are several ways how the DQC-based function ƒ_{θ}(x) can be constructed, leading to varying performance and specific pros/cons when solving particular problems.

Information about the boundary can be included as part of the loss function as defined by Eq. (20). For a MSE loss function type the boundary part Eq. (22) can be written in the form

[symbol]

_{θ}^{(boundary)}[ƒ,x]=η(ƒ_{θ}(x₀)−u₀)², (24)

where x₀ represents the set of boundary points (or an initial point), and u₀ is a vector of boundary values, and η is a pinning coefficient as described above.

In an embodiment, information about the boundary may be included in the expectation of the cost function. This may be referred to as pinned boundary handling. This corresponds to simply choosing a cost operator [symbol] , and representing the solution in the form

ƒ(x)= [symbol] ƒ_{φ,θ}(x)|Ĉ|ƒ_{φ,θ}(x) [symbol] . (25)

The initial value u₀ is then matched to via the boundary term in the loss function. The strength of the pinned boundary handling is in the equivalent treatment of boundary and derivative terms, both being encoded in the eigenspectrum of [symbol] . At the same time, it needs adjusting the boundary value starting from the one represented by initial θᵢₙᵢₜ, typically generated randomly. This can be adjusted by shifting ƒ(x) by a constant-times-identity term added to the cost operator, [symbol] =α₀ [symbol] +Σⱼ₌₁^{M}αⱼ [symbol] , where α₀ is set such that for θᵢₙᵢₜ˜random[0,2π] the function [symbol] ƒ_{φ,θ}_{ᵢₙᵢₜ}(x)| [symbol] |θ_{φ,θ}_{ᵢₙᵢₜ}(x) [symbol] typically lies close to u ₀ value when evaluated at x=x₀.

In a further embodiment, a boundary handler may correspond to iteratively shifting the estimated solution based on the boundary or initial point. For this method the boundary information does not require a separate boundary loss term nor is it encoded in the expectation of the cost function. Instead it is set iteratively within the parametrisation of the function. This method does lead to additional terms in the function and in derivatives calculated and so information about the boundary is contained within [symbol] _{θ}^{(df)}[dₓƒ, ƒ, x] itself. The function may be parameterized as

ƒ(x)=ƒ_{b}+ [symbol] θ_{φ,ƒ}(x)|Ĉ|ƒ_{φ,θ}(x) [symbol] , (26)

with ƒ_{b}∈R being a parameter adjusted after each iteration step as

ƒ_{b}=u₀− [symbol] ƒ_{φ,θ}(x₀)|Ĉ|ƒ_{φ,θ}(x₀) [symbol] . (27)

This effectively allows the solver to find a function [symbol] ƒ_{φ,θ}(x)| [symbol] |ƒ_{φ,θ}(x) [symbol] which solves the differential equation shifted to any position, then being shifted to the desired initial condition as shown in Eq. (26). This method of boundary handling guarantees exact matching to initial values given and does not require a separate boundary term in the loss function, thus the derivative loss term does not have to compete with the boundary loss. Furthermore, as the cost function may be allowed to match to the solution shifted by any amount, this simplifies the choice for optimal angles and removes the dependence on initial θᵢₙᵢₜ. However, this method does require to have an exact initial value which can be an issue in specific situations.

In a further embodiment, a boundary handing technique may be used that relies on the classical shift of the solution, but defined by the gradient descent procedure on par with variational angles optimization. This removes the need to include boundary information in the cost expectation, but information needs to still be included in the loss function whether via a boundary loss term or regularisation. Thus, a solution in the form

ƒ(x)=ƒ_{c}+ [symbol] ƒ_{φ,θ}(x)|Ĉ|ƒ_{φ,θ}(x) [symbol] , (28)

Is sought for, where ƒ_{c}∈R is a variational parameter alongside the quantum ansatz angles and updated accordingly via the classical optimiser, therefore the gradients for ƒ_{c} have to be calculated additionally when using this boundary handler. Strengths of the described method are that due to the classical shift even if the random initial angles start such that [symbol] ƒ_{φ,θ}_{ᵢₙᵢₜ}(x₀)| [symbol] |ƒ_{φθ}_{ᵢₙᵢₜ}(x₀) [symbol] is far from the initial value u₀, the optimiser can quickly and easily update ƒ_{c} to rectify this. In some cases however the boundary and differential terms in the loss may compete against one another.

Given that the aim is to find a variational spectral representation of the differential equations solution using large basis sets, the optimization procedure benefits from having a good initial guess, or “pre-trained” DQCs. This can be achieved by introducing the regularization procedure, also helping avoid getting the optimizer trapped in local minima.

The variants of the regularization procedure include: 1) feeding-in prior information about the potential solution; 2) biasing the DQC-based solution into a specific form; 3) searching solution in the region close to the boundary values, and feeding-in points from the first training into next sessions. The input for procedures 1) and 2) include regularization points for the variable(s) {x_{reg}}ᵣ₌₁^{R}, together with corresponding function values {u_{reg}}ᵣ₌₁^{R} for R points. Similarly, regularization based on the derivative values may be considered. A simple strategy may be employed wherein an additional contribution to the loss function comes from the regularization points, [symbol] _{θ}^{(reg)} [ƒ,x]. This loss is defined such that DQC-based function matches the regularisation values at corresponding grid points. This has a form analogous to the boundary loss contribution. Using MSE loss as example, the regularization contribution reads

$${θ}_{( reg )}^{} [ f , x ] = {\sum }_{r = 1}^{R} ζ ( {n}_{j} ) {( {f}_{θ} ( {x}_{reg , r} ) - {u}_{reg , r} )}^{2} , \qquad ( 29 )$$

where ζ(nⱼ) is introduced as an iteration step-dependent regularization weight, and thus denoting an optimization schedule. In general, higher emphasis on the regularisation-based training at initial stages may be required, which shall diminish to zero at higher iteration numbers. This allows to use a prior information at first, setting a rough solution or preferred function behavior, followed by precise derivative loss optimisation at later training stages.

One possible choice of an optimization schedule corresponds to linearly decreasing regularization weight, ζ(nⱼ)=1−nⱼ/nᵢₜₑᵣ, where nⱼ is current iteration number and nᵢₜₑᵣ the maximum iteration number. This strategy works for small learning rates and large number of iterations, such the optimizer has sufficient “time” to adjust to the constantly changing loss landscape. Another choice corresponds to the reverse sigmoid optimization schedule}, where a smooth drop of regularization weight is performed at pre-defined training stage. This schedule may be parameterized as

$$ζ ( {n}_{j} ) = 1 - tanh ( \frac{{n}_{j} - {n}_{d r o p}}{{δ}_{j} {n}_{i t e r}} ) \qquad ( 30 )$$

where n_{drop} denotes the iteration step number at which regularisation weight drops, and δⱼ assigns the transition rate. This allows the DQC to initially focus almost entirely on the regularization optimization, later switching the focus on the gradient optimization.

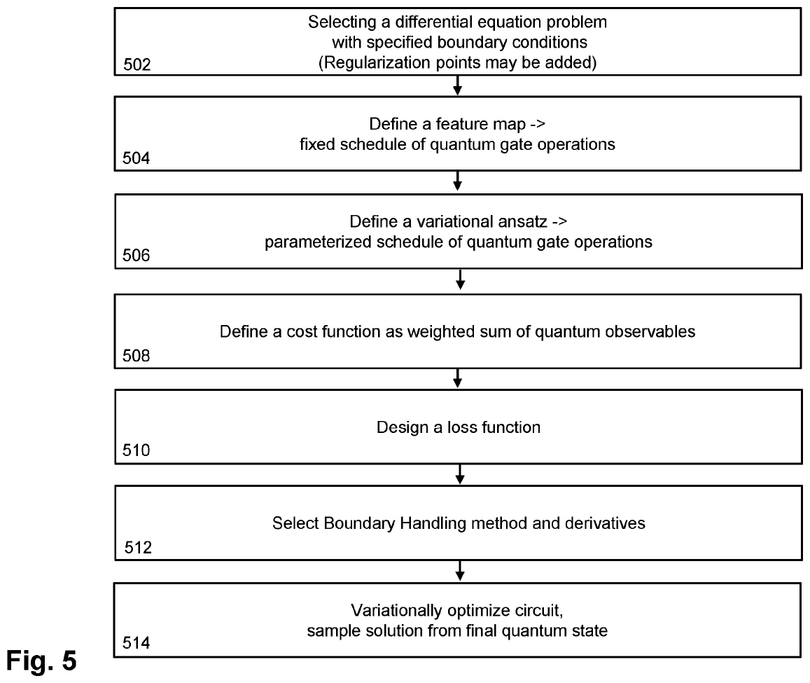

Finally, using the elements and strategies described above, a workflow for constructing the differential equation solver based on derivative quantum circuits described. FIG. 5 schematically depicts a flow diagram of a method for solving general (non-)linear DEs using quantum computation according to an embodiment of the invention. The process may start by specifying the input for a solver 502. This comprises the problem in hand, specified as a set of (non-)linear differential equations of various types, together with their respective boundary conditions. Additionally, a set of regularization points may be added to ensure the optimized solution is chosen in the desired qualitative form. Next, a schedule for derivative quantum circuit optimization may be set up, including the selection of the quantum circuit composition. To that end, a quantum feature map 504 may be defined. Further, an Ansatz of a variational quantum circuit, including its depth 506 may be defined. Additionally, a cost function type may be selected, also choosing if variational weights are considered. Then, a loss function 510 may be selected, which may include a scheme to match the boundary terms 512 and derivatives. Further, a classical optimizer (in short an optimizer) for variational angles and weights (with associated hyperparameters) needs to be defined, including number of iterations and exit conditions. An optimizer refers to an algorithm that is configured to optimize a cost or loss function as a function of variational parameters. Then, the quantum circuit may be variationally optimized in a quantum-classical hybrid loop and thereafter the solution may be sampled from the optimized quantum state 514.

FIG. 6A-6B depict a method for solving general (non-)linear DEs using a quantum computer according to an embodiment of the invention. In particular, FIG. 6A. After determining the quantum circuits and optimization schedule, several initialization steps need to be made 604. First a set of points {X} (a regular or a randomly-drawn grid) may be specified for each equation variable x 606. The variational parameters θ are set to initial values (e.g. as random angles). Then, an expectation value [symbol] C(x, θ) [symbol] over variational quantum state |C_{φ,θ}(xⱼ) [symbol] for the cost function may be estimated 610, using the quantum hardware, for the chosen point xⱼ. Then, a potential solution at this point may be constructed taking into account the boundary conditions.

The derivative quantum circuits may be determined 611 and their expectation value d [symbol] C(x, θ) [symbol] /dx is estimated 610 for the specified cost function, at point xⱼ. Repeating the procedure 606 for all xⱼ in {X}, function values and derivative values may be collected, and the loss function is composed for the entire grid and system of equations (forming required polynomials and cross-terms by classical post-processing) as shown in 612. The regularization points are also added, forcing the solution to take specific values at these points. The goal of the loss function is to assign a “score” to how well the potential solution (parametrized by the variational angles θ) satisfies the differential equation, matching derivative terms and the function polynomial to minimize the loss.

With the aim to increase the score (and decrease the loss function), we also compute the gradient of the loss function 612 with respect to variational parameters θ. Using the gradient descent procedure (or in principle any other classical optimization procedure 614), the variational angles may be updated from iteration nⱼ=1 into the next one nⱼ+1 in step 616: θ⁽ⁿ^{ⱼ}⁾←θ⁽ⁿ^{ⱼ}⁺¹⁾−α∇_{θ} [symbol] (with α being here a ‘learning’ rate). The above-described steps may be repeated until the exit condition is reached. The exit condition may be chosen as:
1) the maximal number of iterations nᵢₜₑᵣ reached;
2) loss function value is smaller than pre-specified value; and
3) loss gradient is smaller than a certain value.

Once the classical loop is exit, the solution is chosen as a circuit with angles θₒₚₜ that minimize the loss. Finally, the full solution is extracted by sampling the cost function for optimal angles [symbol] u_{φ,θ}(x)| [symbol] |u_{φ,θ}(x) [symbol] . Notably, this can be done for any point x, as DQC constructs the solution valid also beyond (and between) the points at which loss is evaluated originally.

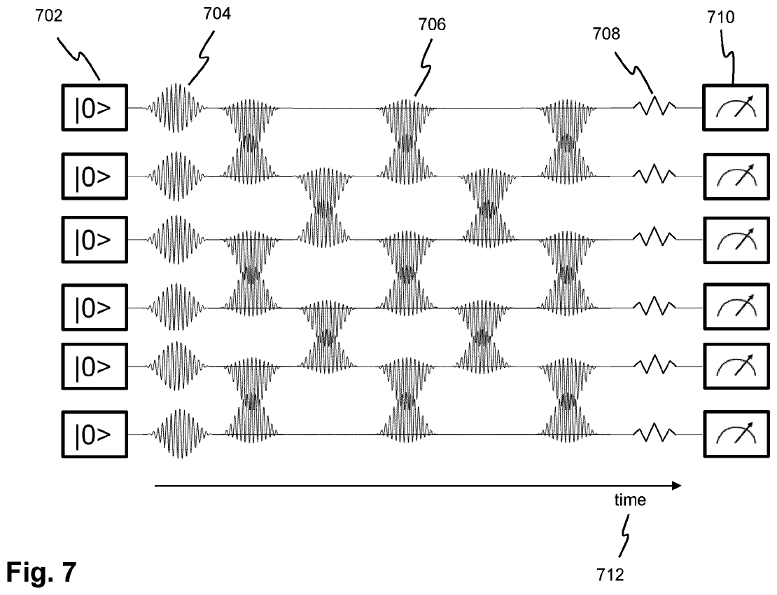

FIG. 7. is a hardware-level schematic illustrating the application of logical operations to qubits using a quantum circuit according to the embodiments in this application, e.g. a quantum circuit as shown in FIG. 6. The ansatz and variational unitaries, 702 and 704 respectively, can be decomposed into a sequence of logical gate operations. These logical gate operations are transformations in the quantum Hilbert space over the qubits. In order to transform the internal states of these qubits, a classical control stack, i.e. a quantum computer controller, is used to send pulse information to a pulse controller that affects one or more qubits. The controller may send a sequence of such pulses in time and for each qubit independently. For example, an initialization pulse may be used to initialize the qubits into the |0> state 702. Then, for example a series of single-qubit pulses may be sent to the qubit array in 704, which may represent the application of a single-layer feature map. Then, two-qubit pulse sequences may be used to effectively entangle multiple qubits 706. The duration, type, strength and shape of these pulses determine the effectuated quantum logical operations. The way the qubit should interact is defined by the quantum feature map circuit and the quantum variational circuit. Reference 708 indicates a ‘break’ in the depicted timeline, which means the sequence of gates may be repeated in a similar fashion in the direction of the time axis 712. At the end of the pulse sequences, the qubits are measured 710.

Hereunder it is described how the algorithm performs in practice. For this a differential equation with known analytical solution may be selected, and compare it to the one obtained by the derivative quantum circuit. We choose a single ODE for the initial value problem which reads

$$\begin{matrix}\frac{d u}{d x} + λ u ( κ + tan ( λ x ) ) = 0 , & u ( 0 ) = {u}_{0} ,\end{matrix} \qquad ( 31 )$$

where λ and κ, and u₀ sets the value of the function u at x=0. Eq (31) has a solution in the form of a damped oscillating function,

u(x)=exp(−κλx)cos(λx)+const, (32)

Where the constant const is determined by the initial condition. While the problem is fairly simple being a single ODE, reproducing the damped oscillating solution requires a reach basis, that needs to include both oscillatoric and increasing/decreasing functions. As λ and κ grow, the function starts to oscillate and decay rapidly, and the solution becomes harder to express.

To show how the proposed method works, derivative quantum circuits are used to solve Eq. 31 using optimization of differentiable quantum feature maps. Specifically, two cases with parameters λ=8 and λ=20 are selected and fixed κ=0.1, u₀=1. Note that parameters are chosen to make DQC construction challenging, with λ=20 being a complex case as the resulting solution is highly nonlinear and oscillatoric. An optimization grid of 20 points may be considered, starting from x=0, with maximal time of 0.9 (dimensionless units are used). To find the solution a quantum register with N=6 qubits may be used, and the cost function is chosen as total magnetization in the Z direction, Ĉ=Σⱼ₌₁^{N}\hat{Z}ⱼ. For the variational circuit, a standard hardware-efficient ansatz described in this application may be chosen, setting the depth to d=5. To search for optimal angles θₒₚₜ adaptive stochastic gradient descent is performed using Adam with automatic differentiation enabled by analytical derivatives. Specifically, the workflow was coded using a well-known package, which allows fast and efficient implementation. A full quantum state simulator is used in the noiseless setting. In this example we use the floating boundary handling.

The circuit-based solution was searched using three different feature maps described in in this application, and their performance was compared. These correspond to the product feature map, the sparse version of the Chebyshev feature map and the tower Chebyshev feature map. Results for these feature maps were labelled as Prod, Cheb, and ChebT, respectively. To assess the performance several metrics may be used. The first metric is the full loss (denoted as L_{F}). It refers to the loss calculated from the differential equations and any boundary or regularisation terms, [symbol] _{θ}[dₓƒ, ƒ, x]= [symbol] _{θ}^{(df)} [dₓƒ, ƒ, x]+ [symbol] _{θ}^{(budr)}[ƒ, x]+ [symbol] _{θ}^{(reg)} [ƒ, x]. The second metric corresponds to differential loss L_{D}, being a part of the full loss excluding regularization contribution. Finally, the third metric is the quality of solution (L_{Q}). The quality of the solution is the distance of the current DQC-based solution from the known true solution. This is calculated by evaluating the DQC-based solution and true solution at a set of points and using the MSE loss type, being equal to L_{Q}=(1/M) Σⱼ₌₁^{M}[ƒ(xᵢ)−u(xⱼ)]². Quality of solution gives us a useful way to compare how two different training setups perform, especially if they are training to solve the same differential equations.

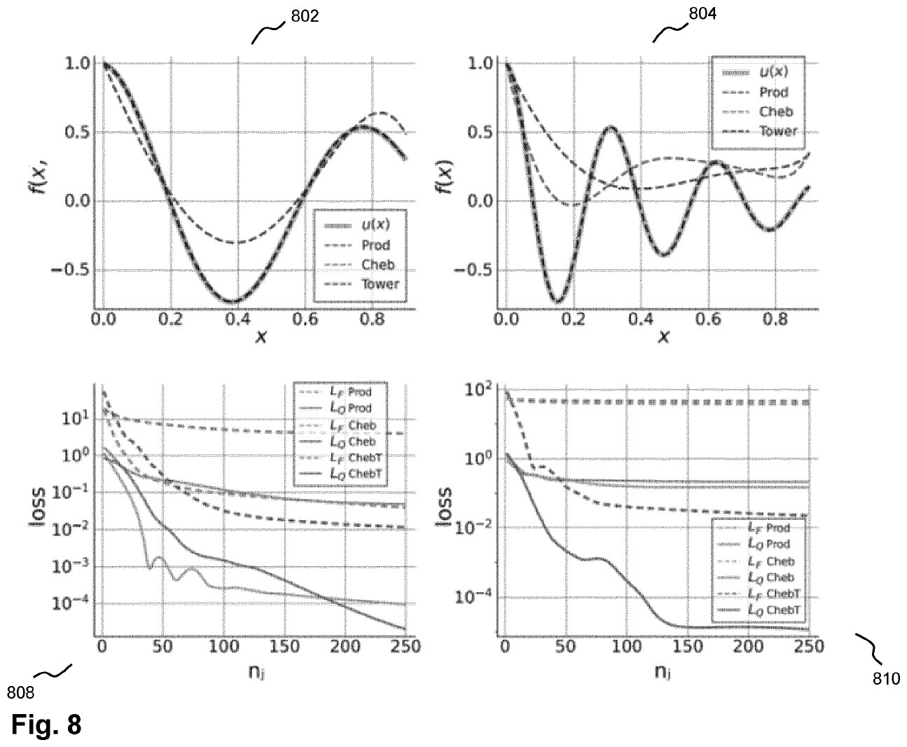

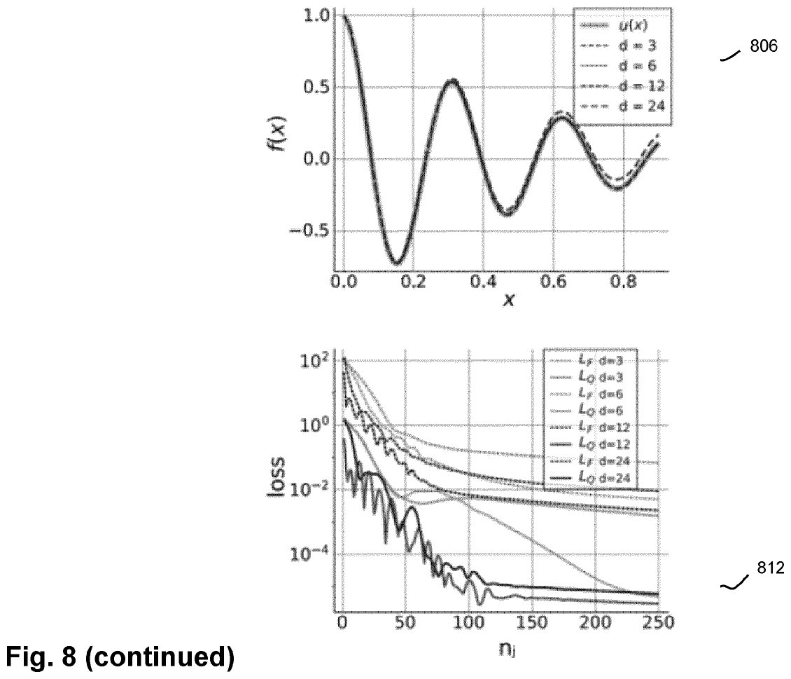

FIG. 8 depicts the resultant DQC-computed solutions using three different feature maps (dashed lines) and comparing to true solution (solid line) for lambda=8 (802) and lambda=20 (804) respectively. Graphs 808 and 810 depict full loss L_{F} (solid curves) and quality-of-solution L_{Q} (dashed curves) shown as a function of iteration number nⱼ for optimization results of graphs 802 and 804, respectively. Graph 806 depicts the DQC-based solution of the damped-oscillator problem, shown for four different ansatz depths d, with the true analytical solution depicted by solid curves. Graph 812 shows the full loss L F (solid curves) and quality-of-solution L_{Q} (dashed curves) shown as a function of iteration number for the solution presented in graph 806.

For λ=8 it is observed that both Chebyshev feature maps converge closely to the true solution. The more expressible Chebyshev tower feature map takes longer to converge but reaches a solution closer to the true solution. The less powerful product feature map fails to converge with the loss quickly plateauing.

For λ=20 the true solution is more oscillatoric and has stronger damping, making the solution harder to represent. The product feature map still fails to converge, but now also failing to converge is the simpler Chebyshev feature map. The full loss for both cases plateaus quickly. The more expressible ChebT feature map continues to perform well. This confirms that choosing a feature map expressible enough for the problem is important, and more simulations with more qubits offers the way to increase the power drastically, however more expressible feature maps can come with increased training time.

Performing the benchmarking for evolution-enhanced feature maps, it is observed that adding an evolution operator T creates a large pool of fitting functions and helps to represent highly oscillatoric functions, as implemented in quantum circuit learning. At the same time, DQCs in this case are more difficult to train, as keeping track of the gradients for oscillatoric function requires finer training grid and has a slower convergence. First, it is envisaged that τ[nⱼ] can be set as a flowing parameter that increases from zero as iteration number nⱼ grows (similar to annealing procedure as in adiabatic quantum computing). This will ensure easy trainability at the start, followed by adjusting θ's for a larger fitting function set providing extra precision. Another approach is considering τ as a variational parameter, initiated at some small value, where gradient descent is performed using numerical differentiation or measuring wavefunction overlaps with the SWAP test.

Finally, the effect of ansatz depths for the variational circuit [symbol] is compared. Here, d=3,6,12,24, λ=20 and the Chebyshev tower feature map but the rest of the training set up remains the same as previously considered. It is observed that for lower depths the solver is slower to converge and does not reach as high accuracy as it does for higher depths. As depth increases, more layers of parametrized gates are included in the variational ansatz and so the number of variational angle parameters increase. This causes an increase in the number of gate operations needed in each iteration and how many parameters the classical optimiser needs to update, raising the time taken per iteration. As the depth of the ansatz continues to increase eventually the problem of barren plateaus could be encountered. Then vanishing gradients would cause the solver to struggle to improve the parameters, however at d=24 with over 400 variational parameters these problems were not observed.

Building up on the single ODE example, systems of differential equations may be considered, taking two strongly coupled differential equations as an example. These equations may describe the evolution of competing modes u₁(x) and u₂(x) as a function of variable x, which in this case corresponds to time. The associated rate equations read

$$\begin{matrix}{F}_{1} [ {d}_{x} u , u , x ] = \frac{d {u}_{1}}{d x} - {λ}_{1} {u}_{2} - {λ}_{2} {u}_{1} = 0 , & {u}_{1} ( 0 ) = {u}_{1 , 0}\end{matrix} , \qquad ( 33 )$$

$$\begin{matrix}{F}_{2} [ {d}_{x} u , u , x ] = \frac{{du}_{2}}{d x} + {λ}_{2} {u}_{2} + {λ}_{1} {u}_{1} = 0 , & {u}_{2} ( 0 ) = {u}_{2 , 0} ,\end{matrix} \qquad ( 34 )$$

where λ_{1,2} are coupling parameters, u_{1,0}, u_{2,0} are initial conditions. The larger |λ₁| is in comparison to |λ₂| the more strongly coupled the two equations will be. This can be intuitively seen considering |λ₁| leading to larger contribution of u₂ into the equation for du₁/dx derivative than u₁, and vice versa.

To move from considering one differential equation to a system of equations we need to encode multiple functions using quantum circuits as described with reference to the embodiments in this application. For this specific example a simple parallel encoding may be selected, where separate cost functions and ansatzes are considered. In this case each function has a separate set of parameters to be optimised. The loss is changed accordingly to include information on separate contributions from two coupled differential equation that are optimised simultaneously. We encode each function using the differentiable feature map combined with individual variational ansatz parametrized by the set of angles θ₁ and θ₂ and before deciding on the boundary evaluation type we have

ƒ₁(x)= [symbol] Ø [symbol] _{ϕ}^{†}(x) [symbol] _{θ}_{₁}^{†}Ĉ⁽¹⁾ [symbol] _{θ}_{₁} [symbol] _{ϕ}(x)|Ø [symbol] , (35)

ƒ₂(x)= [symbol] Ø [symbol] _{ϕ}^{†}(x) [symbol] _{θ}_{₂}^{†}Ĉ⁽²⁾ [symbol] _{θ}_{₂} [symbol] _{ϕ}(x)|Ø [symbol] , (36)

where Ĉ^{(1,2)} are in principle disserent cost functions for each equation. For the loss function we consider the sum of the MSE losses for the first and second differential equation. This loss is written as [symbol] _{θ}[dₓƒ, ƒ, x]=Σᵢ₌₁^{M}L(F₁ [dₓƒ, ƒ, xᵢ], 0)+Σᵢ₌₁^{M}L(F₂ [dₓƒ, ƒ, xᵢ ], 0) with F₁ and F₂ as written in Eq. (33)-(34), and L depends on the loss choice as detailed in the Methods section. There can be additional boundary loss terms depending on boundary evaluation method chosen. If present, they contribute to the loss function as a sum of the boundary terms for u₁ and u₂. Note that we consider the loss as a sum of individual contributions coupled together we are trying to minimise both simultaneously with equal weight. Due to the coupling between the two equations this could lead to competition between the two loss terms (a parameter update which would cause a loss decrease for one DE's loss may lead to an increase in the other). This may result in increasing the chance of converging to a local minima rather than the global minimum, that can be mitigated if loss contribution are weighted in some way.

We define the problem setting parameters to λ₁=5, ˜λ₂=3 and initial conditions to u_{1,0}=0.5, ˜u_{2,0}=0. We set up the training scheme using a six-qubit register, cost choice of total magnetization in the Z direction for both u₁ and u₂, hardware-efficient variational ansatz with depth d=5, ADAM optimizer with learning rate 0.02, and feature map choice of the Chebyshev tower feature map. We test the performance for the three boundary evaluation types: pinned boundary, floating boundary, and optimised boundary.

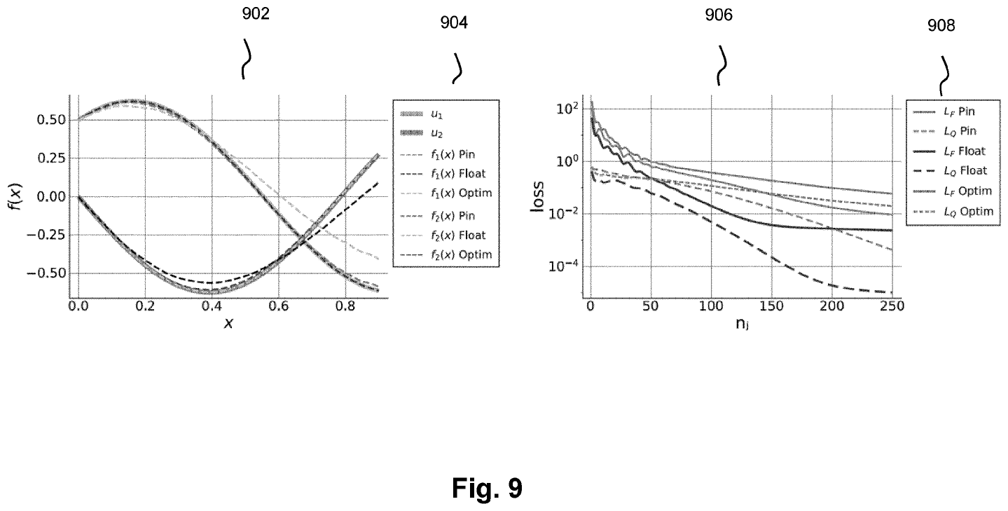

FIG. 9 depicts the results for a system of strongly coupled equations. The first graph 902 shows the resultant estimated function for a system of strongly coupled equations with λ₁=3 and λ₂=5 for pinned boundary (Pin), floating boundary (Float), and optimised boundary (Optim). Second graph 904 shows the loss function values as a function of iteration number for trainings as displayed in Graph 902. In graph 904, solid lines denote full loss L F and dashed lines denote quality of solution L_{Q}.

The pinned and optimised boundary handlers perform similarly, slowly converging to the analytical solution u_{1,2} (x) within 250 iterations. The two approaches have similar convergence in terms of the full loss, but differ in terms of quality of solution. When using floating boundary type a function close to the true solution is obtained (with L_{Q} value of approximately 10⁻⁴). This difference in convergence rate is a result of boundary information having an impact on the loss, demanding the matching for pinned and optimized boundary handlers, whereas the floating boundary automatically matches the initial condition and no loss boundary term is needed. The consequence of competing terms in the loss function can be seen in the early oscillations of the full loss as shown in the figure.

An area where solvers for complex differential equations are much required is fluid dynamics. In this case several outstanding models are hard to tackle due to their nonlinear nature and possible discontinuous solutions in the form of shock waves. Examples include Burger's equation and Navier-Stokes equations. We concentrate on the latter and show how one can approach it with the DQC solver.

Navier-Stokes equations describe a flow of incompressible fluids. This highly nonlinear set of partial differential equations is used to model fluids, magnetoplasma, turbulence etc. It is heavily used in the aerospace industry and weather forecasting. It can be derived from general principles. Namely, we consider fluid motion that obeys Newton's law and we simply track the fluid mass passing through the (infinitesimal) volume. The general form Navier-Stokes equation can be presented in the form:

$$\frac{\partial ( ρ {v}_{x} )}{\partial t} + ∇ \cdot ( ρ {v}_{x} V ) = - \frac{\partial p}{\partial x} + \frac{\partial {τ}_{xx}}{\partial x} + \frac{\partial {τ}_{yx}}{\partial y} + \frac{\partial {τ}_{𝓏 x}}{\partial 𝓏} + ρ {f}_{x} \qquad ( 37 )$$

$$\frac{\partial ( ρ {v}_{y} )}{\partial t} + ∇ \cdot ( ρ {v}_{y} V ) = - \frac{\partial p}{\partial x} + \frac{\partial {τ}_{xy}}{\partial x} + \frac{\partial {τ}_{yy}}{\partial y} + \frac{\partial {τ}_{𝓏y}}{\partial 𝓏} + ρ {f}_{y} \qquad ( 38 )$$

$$\frac{\partial ( ρ {v}_{𝓏} )}{\partial t} + ∇ \cdot ( ρ {v}_{𝓏} V ) = - \frac{\partial p}{\partial x} + \frac{\partial {τ}_{x𝓏}}{\partial x} + \frac{\partial {τ}_{y𝓏}}{\partial y} + \frac{\partial {τ}_{𝓏𝓏}}{\partial 𝓏} + ρ {f}_{𝓏} \qquad ( 39 )$$

where (vₓ, v_{y}, v_{z}) are instantaneous velocities in the (x, y, z) directions, τ is the stress tensor, ƒ the body force per unit mass acting on the fluid element, ρ the density, and p the pressure. Here V is a velocity field.

The building blocks for the Navier-Stokes equations described above are the continuity equation for the density ρ subjected to energy conservation and the momentum conservation rules. Finally, as we use energy conservation, we can rewrite equations in terms of one of the thermodynamic state functions, being temperature, or pressure, or enthalpy etc.

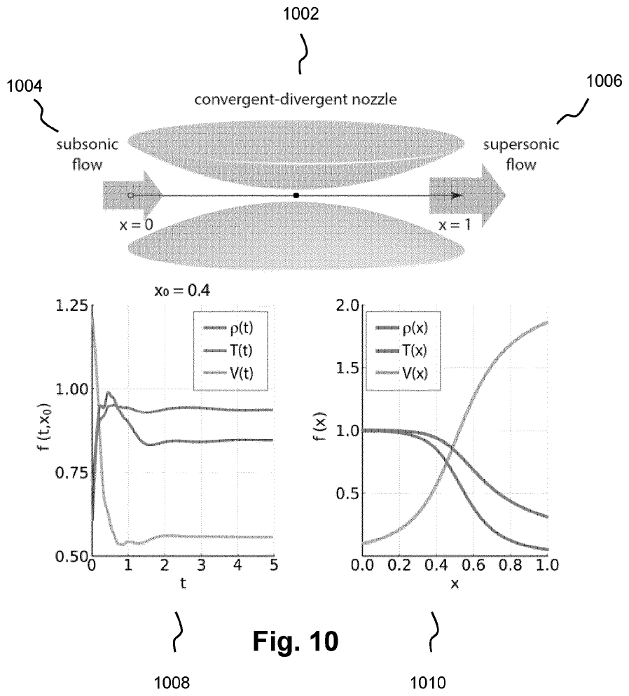

While general by itself, Navier-Stokes equations are usually solved in relevant limiting cases. Specifically, this can correspond to space reduction (2D, quasi-1D, 1D), isotropic/anisotropic media properties, and fluid properties (viscous or inviscid flow). FIG. 10 depicts a schematic of a flow through a convergent-divergent nozzle and numerical results obtained by standard classical solvers. The physical layout of the system considered is shown in 1002. An input subsonic flow is considered 1004, which undergoes compression in the center of the nozzle, and for certain boundary conditions exhibits supersonic flow at the output 1006. The equations can be derived for inviscid fluid in quasi-1D approximation. They read

$$\frac{\partial ρ}{\partial t} = - ρ \frac{\partial V}{\partial x} - ρ V \frac{\partial ( log A )}{\partial x} - V \frac{\partial ρ}{\partial x} , \qquad ( 40 )$$

$$\frac{\partial T}{\partial t} = - V \frac{\partial T}{\partial x} - ( γ - 1 ) T ( \frac{\partial V}{\partial x} + V \frac{\partial ( log A )}{\partial x} ) , \qquad ( 41 )$$

$$\frac{\partial V}{\partial t} = - V \frac{\partial V}{\partial x} - \frac{1}{γ} ( \frac{\partial T}{\partial x} + \frac{T}{ρ} \frac{\partial ρ}{\partial x} ) , \qquad ( 42 )$$

where Eq. (40) corresponds to the continuity equation, Eq (41) describes the energy conservation, and Eq. (42) stems from momentum conservation. A(x) corresponds to the spatial shape of the nozzle, and essentially is a potential as a function of the lateral coordinate x. γ describes the ratio of specific heat capacities, and is equal to 1.4 for the relevant case of air flow. Here nondimensional variables were used.

The problem with nozzle shape was set as follows:

A(x)=1+4.95(2x−1)²,0≤x≤3, (43)

and specify boundary conditions as

ρ(x=0,t)=1,T(x=0,t)=1,V(x=0)=0.1, (44)

for concreteness solving the initial value problem. Also the initial conditions needs to be specified if solving the dynamical problem. These may be chosen as follows:

ρ(x,t=0)=1−0.944x, (45)

T(x,t=0)=1−0.694x, (46)

V(x,t=0)=(0.1+3.27x)T(x,t=0)^{1/2}. (47)

First, the stationary state problem represented by Eqs. (40)-(42) with conditions above are considered, and equate the time derivatives to zero. Interestingly, when trying to solve the system for the steady state solution using various classical methods, implemented in Mathematica's NDSolve or Julia's software package, the calculations do not converge. This proves to be challenging as the system is stiff. Solutions may become unstable depending on initial values, and specifically the input velocity. To understand the problem, it is instructive to rewrite the system of stationary Navier-Stokes equations in the form:

$$\frac{d ρ}{dx} = \frac{ρ {V}^{2} {d}_{x} ( log A )}{T - {V}^{2}} , \qquad ( 48 )$$

$$\frac{dT}{dx} = \frac{T {V}^{2} ( γ - 1 ) {d}_{x} ( log A )}{T - {V}^{2}} , \qquad ( 49 )$$

$$\frac{dV}{dx} = - \frac{T {Vd}_{x} ( log A )}{T - {V}^{2}} . \qquad ( 50 )$$

Immediately it was observed that each function at the RHS diverges at the point x s.t. T(x)=V(x)². This leads to singular behaviour and breaks classical solvers, including the ones with stiff handling. At the same time, full dynamical solution and it t→∞ extrapolation are possible. Graphs 1008 and 1010 of FIG. 10 here show numerical results achieved by standard classical solvers, in order to compare to and benchmark the performance of the DQC solver. System variables (density, temperature, and velocity) are shown 1008 as a function of time, at the center of the nozzle. Further, steady state solutions 1010 are plotted as a function of spatial dimension x.

To construct the solution a two-stage optimization approach may be employed, where the solution is first obtained at smaller x, and later generalized until the end of the nozzle. For the circuit a six-qubit quantum register may be considered with a Chebyshev quantum feature map, keeping in mind that x∈[0,1). The cost function may be chosen as the total magnetization [symbol] =Σⱼ₌₁^{N}\hat{Z}ⱼ. Because three functions {ρ(x), T(x), V(x)} are considered, three equations contribute to the loss function in the combined manner. Floating boundary handling may be used, where each curve is adjusted according to starting values, chosen as ρ(0)=1, T(0)=1, V(0)=0.1. The variational ansatz is taken in the standard hardware efficient form with d=6 depth. Adam is used as a classical optimizer, and the learning rate is set to 0.01.

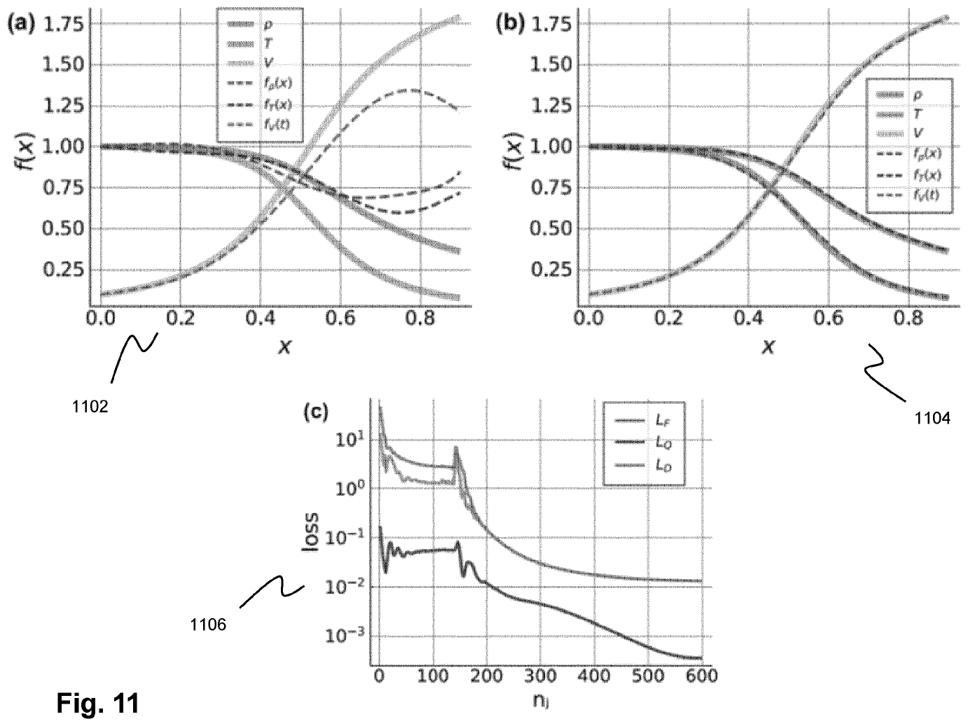

FIG. 11 shows a DQC solution for the Navier-Stokes differential equation problem. At the first stage we train DQC in the region (xₘᵢₙ, xₘₐₓ)=(0, 0.4), such that the circuit represents the region close to initial point x=0. As expected, in the subsonic region flow velocity grows towards the middle of the nozzle, while temperature and density slowly drop. The training is set for 20 equally distributed points of x, with no prior regularization and adjustable boundary. We optimize DQC for nᵢₜₑᵣ=200 iterations for Adam with the learning rate of α=0.01. We find high-quality solution based on the gradient information in the imposed solution region x<0.4 shown in graph 1102 of FIG. 11, while grey area depicts generalized solution for points without prior training. We note that the loss function for strongly coupled Navier-Stokes equations has a complicated landscape. As different terms in the loss can compete with each other, to choose an overall shape of solution one can use the regularization technique.

We proceed to search for the full solution that includes the divergent nozzle part for x>0.5 at the second training stage. At this session we choose the grid of 40 points, where to regions of (0, 0.4) and (0.6, 0.9) with 20 points each are used. As we discussed before, the key problem of the convergent-divergent nozzle in the subsonic-supersonic transition case is the divergence around the middle of the nozzle. This causes a major problem to classical solvers, that are unable to find steady state solution. Divergent contribution from this region also impacts the loss function, and makes training complicated. However, by excluding the region around the nozzle throat, (0.4, 0.6), in the training this problem was alleviated. Proceeding with the use of the same ansatz and boundary handing, and feed the variational angles from stage 1 as initial parameters leading to sub-optimal solution. We employ weak regularization to ensure that required subsonic-supersonic solution is made. Namely, we use 20 points in the (0, 0.4) region benefiting from the previously found solution (in general we have access to as many points as we need), and also add 5 points in the x∈(0.6,0.9) region representing weak bias towards desired solution. The training is performed for nᵢₜₑᵣ=600, learn rate of α=0.005 regularization switch-off function ζ(j) set to remove smoothly the regularization weight around j=150. The full solution is shown in graph 1104 of FIG. 11. It converges to the expected long-time behavior for the system, where function derivatives from DQC nicely match the nonlinear contributions. The increase of speed for the air flow in the convergent part and decrease of temperature and density is reproduced quantitatively. The details of optimization run can be inferred from the loss plotted in graph 1106 of FIG. 11. This shows a distinct region in the presence of regularization (nⱼ<150), where quality of solution L_{Q} remains low, while the full loss L_{F} improves thanks to regularization contribution and weakly improved derivative contribution L_{D}. For the region with switched regularization we observe steady improvement of all metrics, showing that DQCs are efficiently trained to approach true solution, also evidenced by L_{Q} decrease. Notably, as compared to many methods relying on sparse discretization of x, we have found solution along the full nozzle length.

The embodiments describe in this application define a general framework for solving general (systems of) differential equations using differentiable quantum circuits on gate-based quantum hardware. The method makes use of quantum feature map circuits to encode function values into a latent space, which allows us to consider spectral decompositions of the trial solutions to differential equations. The differential quantum devices can accurately represent non-linear solutions using few qubits, by exploiting a number of spectral basis functions exponential in the number of qubits.

Analytical circuit differentiation can be used to represent function derivatives appearing in differential equations. The embodiments also show how analytical circuit differentiation can be used to represent function derivatives appearing in differential equations, and constructed loss functions which aim to improve the prepared trial solution. The embodiments open up a new way of solving general, complex, (non-)linear systems; as an example, solutions to the Navier-Stokes equation were presented, but the same method can be applied across all disciplines where differential equations arise. Further it is well-known that the analytical gradients, which are used here, are much less susceptible to noise than numerical gradients evaluated on variational quantum circuits. Noisy black-box optimization algorithms for NISQ application would perform well in this method.

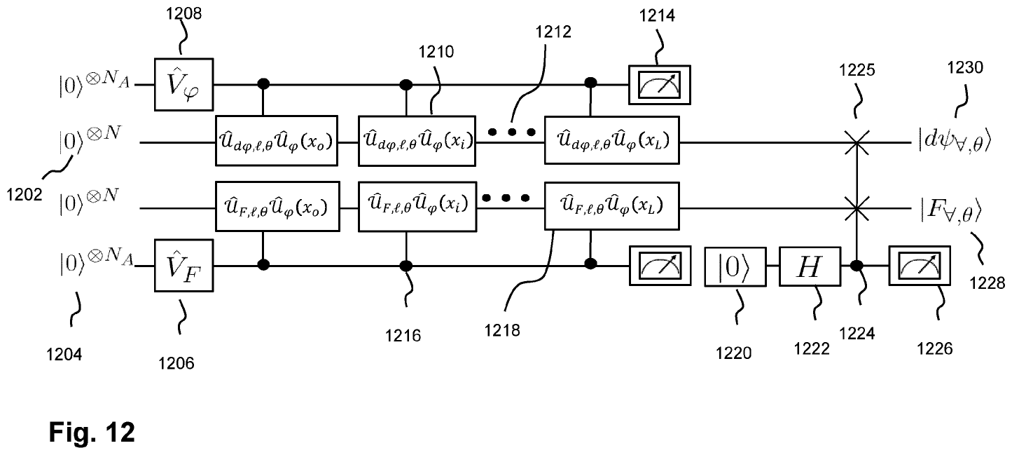

FIG. 12 depicts a quantum circuit for a post-NISQ DQC-based scheme according to an embodiment of the invention. One may start by applying quantum feature map encoding |ƒ(x) [symbol] := [symbol] _{θ} [symbol] _{φ}(x)|Ø [symbol] to the starting state, denoting this state as a wavefunction representation of the solution. This corresponds to the high-dimensional latent space representation of the sought function. The differentiated state can be obtained from the feature map derivative, as for instance shown in Eq. (7), leading to

$$\frac{d \vert f ( x ) 〉}{d x} = ( x ) \vert ∅ 〉 , \qquad ( A1 )$$

where unitary operators [symbol] correspond to shifted feature map circuits. Importantly, Eq. (A1) represents a linear combination of unitaries (LCU) acting on the initial state. While LCU is a non-unitary operation in itself, using an ancillary register one can simulate its action efficiently using controlled operations.
First the general implementation of LCU operations is shown. To implement an action of the sum of unitaries on the initial state as Ŝ|ψ₀ [symbol] := [symbol] for real coefficients [symbol] >0 we need an additional register with N_{A}=[log₂(L)] qubits. Also an operator \hat{V} acting on ancillas as \hat{V}|0 [symbol] ^{⊗N}^{_{A}}:=(1/\sqrt{c}) [symbol] , c [symbol] is required, creating a superposition state to yield sum-of-unitaries state preparation flagged by bitstrings [symbol] . Each bitstring then flags a unitary in the sum as controlled operation [symbol] acting on N_{A} ancilla qubits and N-qubit system register. The effective action of the LCU corresponds to the combined application of operator Ŵ:=\hat{V}^{†}Û\hat{V}. Acting on the initial state this leads to:

$${{\hat{W} \vert 0 〉}^{⊗ {N}_{A}} \vert ∅ 〉 = \frac{1}{c} \vert 0 〉}^{⊗ {N}_{A}} \hat{S} \vert ∅ 〉 + \vert ⊥ 〉 , \qquad ( A2 )$$

where ⊥ [symbol] is an orthogonal state where the system is projected once LCU implementation did not work. Performing measurement of N_{A} ancilla qubits, the system collapses to the normalized LCU state Ŝ|Ø [symbol] once 0 bits are read out on the ancillary register. The probability of implementing Ŝ|Ø [symbol] operation depends on the sum of expansion coefficients as p=1/c².

Using the general LCU framework, known to provide exponential speed-up for quantum simulation and matrix inversion. FIG. 13 illustrates how this technique may be applied to the DQC method. The training of latent space solution state |ƒ(x) [symbol] can be performed by considering the function at the set of points [symbol] as a superposition:

$$\vert {ψ}_{∀} 〉 = \vert i 〉 ⊗ ( {θ}_{} {φ}_{} ( {x}_{i} ) \vert ∅ 〉 ) , \qquad ( A3 )$$

where states of the ancillary register 1204 flag the feature map application in a specific point. Similarly, the derivative evaluated at the grid of [symbol] points reads as follows:

$$\vert d {ψ}_{∀} 〉 := \vert i 〉 ⊗ ( ( {x}_{i} ) \vert ∅ 〉 ) , \qquad ( A4 )$$

with slightly expanded register to accommodate for the sum of unitaries representing the circuit derivative. This procedure can be generalized to higher-order derivatives. Importantly, exponentially many points can be encoded as number of states in {|i [symbol] } grows as 2^{N}^{_{A}}. Once the differentiated state 1230 on register 1202 is prepared, the same procedure may be applied for the RHS of the differential equation F[ƒ, x] on register at 1228. In general, this comprises of functions and variables of different degree, which may be defined as

$$F [ f , x ] = {n}^{{n}_{l}} {f ( x )}^{{m}_{l}} , \qquad ( A5 )$$

where l is a superindex for pairs of degrees spanning over the set [symbol] . The next goal is to write the information about structure of F[⋅] as a quantum register. With a linear function simply the unitary feature map is applied. For functions in higher powers use QNPUs need to be used that multiply states in the unitary fashion. Finally, monomials of variable serve as weights. Using same steps as before we arrive to

$$\vert {F}_{∀} 〉 := \vert i 〉 ⊗ ( ( x ) {φ}_{} ( {x}_{i} ) \vert ∅ 〉 ) , \qquad ( A6 )$$

implemented with an ancillary register 1204 (may be different from the derivative part). Finally, the training needs to be performed using the two-part cost function [symbol] = [symbol] _{diff}+ [symbol] _{bound}. First, functions in the latent space may be matched by maximising their overlap as

[symbol]

_{diff,θ}=(1−| [symbol] dψ_{∀,θ}|F_{∀,θ} [symbol] ²) (A7)

and

[symbol]

_{bound,θ}=(u₀− [symbol] ψ_{∀,θ}(x=0)|Ĉ|ψ_{∀,θ}(x=0) [symbol] )². (A8)

keeping in mind θ parametrization. This overlap maximizing can be achieved by using the SWAP test protocol, depicted schematically in 1220, 1222, 1224,1225,1226. Matching the two parts at all points simultaneously the solution to the differential equation system can be found.

FIG. 13A-13C illustrate different types of differential equations that can be solved using the embodiments in this patent application. In each of these examples, the objective is to ‘solve’ (generalize) the model, such that values of a function 1312 can be determined at any point in the domain x 1316. In FIG. 13A, an exact knowledge of the differential equation is given 1306 and no other input data except boundary conditions 1311 is provided. In other words, there is no assumed uncertainty in the equation parameters 1308. A trial solution 1310 is trained to fit the differential equation and boundary condition by including those as terms in a loss function according to the schemes described with reference to FIG. 1-7 above, until a solution 1314 is found.

FIG. 13B illustrates an example of a parameterized differential equation, wherein one or more of the elements in the equation are (hyper)parameters (α,β) rather than functions (ƒ(x),g(x, y)) or dependent/dimensional variables (x, y, z, t). Such parameters may also be referred to as coefficients. To solve such equations for a specific instance, additional data is required and used as boundary conditions on the parameters, and regularization in the form of initial suggested values for the parameters may be given.

Suggestions for the values of the parameters in the terms in the equation 1320 may be provided in as approximate values (rather than exact values). Initial suggested parameter values may be provided as regularization data for use during the training process. An example of the loss contribution that would effectively enable this is:

$${α}_{( par , reg )}^{} = {\sum }_{i} {ζ}_{α} ( {n}_{j} ) {( {α}_{i} ( {n}_{j} ) - {α}_{i} ( 0 ) )}^{2} \qquad ( A9 )$$

where zeta may be some function similar to Eq. 30, epoch-dependent. The parameters 1320 are initialized in αᵢ(0) and any deviation is initially punished with this loss term in order to first push the solver to find solutions close to the original estimated DE form. In the final epochs of optimization, this loss contribution may be completely turned off such that DE hyperparameters alpha are fully variationally optimized to fit the observations.

The goal of solving the differential equation in such setting is then achieved by also relying on experimental data/measurement points that are already known 1322. These can be just a few points but should be known with some non-negligible certainty. In an embodiment, these data points may be added as representing parameter boundary conditions in a regression strategy wherein differential-equation-matching, boundary-condition-matching, and prior-knowledge-data-matching are ensured. In this way, a generalized solution to the equation can be found, while simultaneously finetuning the values of the equation parameters with higher accuracy given the data. Hence, these embodiments enable parametrized differential equation solving using tunable variational equation parameters on equal footing with circuit parameters.

FIG. 13C illustrates another example of a parameterized differential equation. In particular, the figure illustrates a parameterized differential equation similar to FIG. 13B which is extended to encompass terms that may have coefficients equal to zero, but it is not known a-priori whether they are non-zero or zero. Such parameterized differential equation may therefore be written in a general form as:

$$LHS = 𝓌 \cdot F [ f , \frac{d f}{d x} , x , … ]$$

where the dot indicates a vector inner product, wherein a parameter may be represented as a vector of coefficients [symbol] and F is a vector of functionals on ƒ and x. In other words, the right-hand side RHS of this equation can be any linear combination of a set of library terms that are expected to be relevant to solving the differential equation. During the loss function optimization, now both the function parametrization, θ as well as the function coefficients, [symbol] , are optimized just like in the case of FIG. 13B. The difference here is that we are not sure a-priori that all the terms in the given library are ‘correct’; that needs to be learned from the information in the data loss term. The left-hand side LHS can be one or more known terms involving ƒ or x. At least one term needs to be known, otherwise the system is underdetermined even with data.

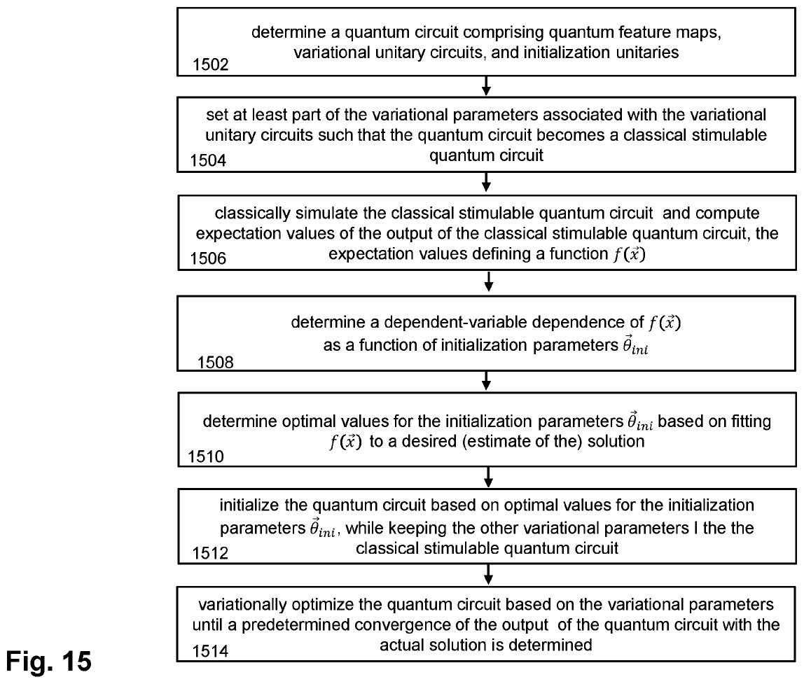

In FIG. 13C, the data points and trial function for y may be the same as in FIG. 13B however the differential equation that is modelled is different. It is still assumed that one of the terms 1326 exists, and it may also include hyperparameters 1328,1336 that are similar to those described with reference to FIG. 15B, however other terms 1330,1332,1334 for which it is a-priory not known whether they should be included or not, but for which it is nevertheless desired to learn their coefficients and/or presence/absence. The goal is to learn coefficients [symbol] such that the equation fits the data, and in the process solve the differential equation. For this case of DQC, the loss function will look similar as in Equation (21):

$${θ , w}_{( diff , disc )}^{} [ {d}_{x} f , f , x ] = \frac{1}{M} {\sum }_{i = 1}^{M} L ( LHS , w \cdot F [ f ( {x}_{i} ) , {d}_{x} f ( {x}_{i} ) , {x}_{i} , … ] )$$

Also, an additional Loss term for weight-regularization purposes may be introduced:

[symbol]

_{reg,} [symbol] =∥ [symbol] ∥

This loss term ensures that non-important or unlikely terms are suppressed in the optimization over [symbol] , in some sense increasing sparsity in the [symbol] structure. This is useful, as most processes in nature can be described with relatively few terms, and the challenge is often rather which of those terms should appear and with what strength.

FIG. 17 illustrates an example of a process of solving a parameterized differential equation using DQC according to an embodiment of the invention. The figures illustrate a workflow including DQC steps. The example regards a differential equation modelling a damped harmonic oscillator 1702. The function u represents the position of the oscillator and t is the time variable. By means of illustration, it is assumed that not only the coefficients are unknown, but also that it is not known exactly which terms will appear. Instead, a real-world experiment on a damped oscillator is performed and observed data show how the function u moves as a function of time. These measurement data are the circular data points in plot 1704. Thereafter, these data are fitted with a parametrizable function u, which can be represented with DQCs. Functional block 1706 includes quantum circuits, such as quantum feature maps and variational quantum circuits representing a function and its derivative as e.g. explained with reference to FIGS. 2 and 3 to arbitrary variables.

A trial model 1708 may be used to narrow down the generality, wherein the trial model may indicate that at least one of the terms, in this example the double derivative with respect to time ∂uₜₜ, exists in the model for sure. Further, a library of functionals φ(u) may be used, wherein the aim of the scheme is to learn their coefficients, wherein a zero coefficient implies absence of the term. The loss function may be differentiated with respect to both theta 1710 and [symbol] 1711, so that both the function shape and the model fit can be optimized. Graph 1712 illustrates how DQC manages to find the correct parameters for the example of a damped harmonic oscillator within approx. 150 iterations of the algorithm. The final results are the coefficients of the trial model 1708 shown in 1714. We find that only the linear term and the derivative with respect to time are non-zero coefficients, and we also find those coefficients to accurately represent the values that we used to generate the data in this case. This shows one can effectively solve differential equations based on partial knowledge of the underlying model, combined with data/observations of the physical or observed process, using DQC.

In an embodiment, non-regularization (real) information, data points, physical measurements, or any other a-priori known data may be used to solve systems of parametric differential equations where parameters of the equation are not exactly known or known to low degree of confidence. Those data points may be considered in the total loss function in order to perform partial regression on the data while still conforming to the (set of) differential equations. Such loss term contribution may have the following form as an example:

$${θ}_{( data )}^{} [ f , x ] = {\sum }_{i} {{η}_{i} ( {f}_{θ} ( {x}_{i} ) - {u}_{i} )}^{2} \qquad ( A 10 )$$

Where uᵢ are given known function values at data points xᵢ. The importance of these data can be tuned with η but is epoch-independent, and therefore behaves similar to a boundary loss term.

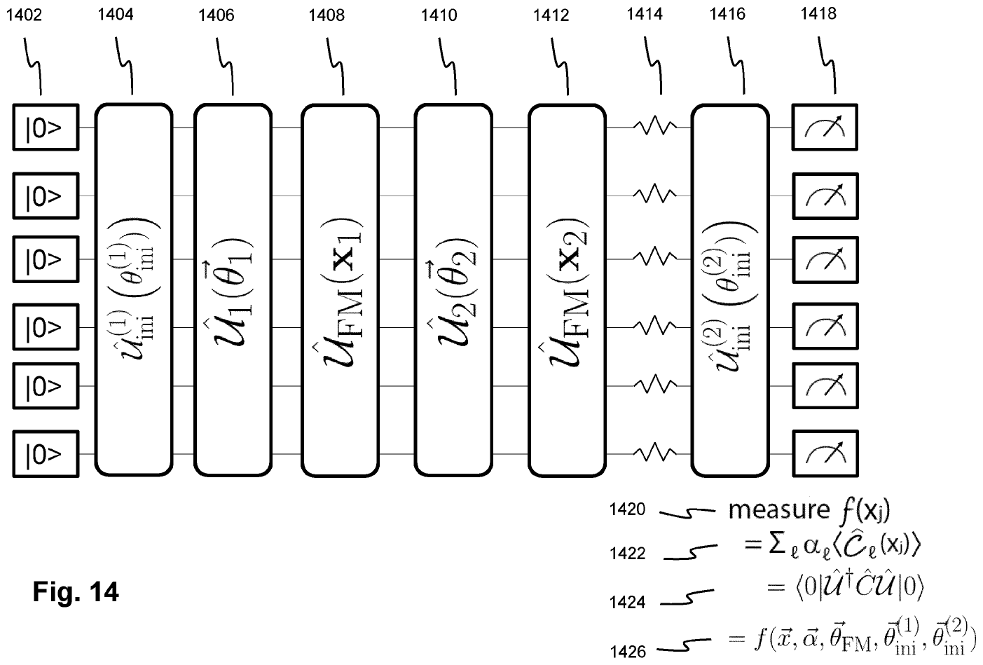

FIG. 14 depicts a schematic of a quantum circuit according to an embodiment of the invention. In particular, the figure illustrates a parametrized quantum circuit similar to the example described with reference to FIGS. 2A and 2B, however in this embodiment, the quantum circuit may include a plurality of different quantum sub-circuits, each being associated with different functionality. For example, the sub-circuits may include one or more quantum feature maps [symbol] _{FM}(\vec{x}₁), [symbol] _{FM}(\vec{x}₂) 1408, 1412 each mapping a variable of the differential equation to the Hilbert space associated with the qubits. Further, the sub-circuits may include one or more quantum sub-circuits that are configured as variational unitaries [symbol] ₁(\vec{θ}₁), [symbol] ₂(\vec{θ}₂) 1406, 1410 associated with one or more variational parameters \vec{θ}₁, \vec{θ}₂ (which may be represented as vectors). These variational parameters may be used for training the parametrized quantum circuit to approximate a solution to the differential equation, i.e. a trial function ƒ(\vec{x}₁, \vec{x}₂), for different values of \vec{x}₁ and \vec{x}₂.

The computation of a trial function ƒ 1426 may be summarized by equation 1424 indicating that the function is the expectation value of a predefined Hermitian cost operator Ĉ as described with reference to Eq. (1). The function may depend on one or more vectors \vec{x} defining the variable(s) of the differential equation, a vector \vec{α} defining a classical optimization parameter and one or more variational parameters \vec{θ}₁, \vec{θ}₂. In some embodiments, a quantum feature map may also depend on a variational parameter \vec{θ}_{FM}. Further, in an embodiment, one or more initialization unitaries [symbol] ᵢₙᵢ⁽¹⁾(\vec{θ}ᵢₙᵢ⁽¹⁾), [symbol] ᵢₙᵢ⁽²⁾(\vec{θ}ᵢₙᵢ⁽²⁾) 1404, 1416 may be used to initialize variational parameters of the quantum circuit.

The line break 1414 signifies that any of the components shown may or may not be repeated or similar components can be introduced as required by the application. Qubits may be initialized in the |Ø [symbol] state 1402, and after application of the qubit operations represented by quantum circuits 1404-1416 outputs may be measured in the X, Y or Z basis 1418 in order to compute expectation values of operators 1422 which sum up to a function expression 1420.

As described with reference to FIG. 6, the variational parameters need to be set to initial values, such as random angles. Starting with a completely random circuit however may give a trial function that is so far off the correct solution that it does not converge to a good approximation, or such that it does not converge sufficiently fast to a good approximation.

Therefore, in an embodiment, instead of random values, a predetermined set of angles may be used for initialization of the variational parameters. In particular, in an embodiment, one or more initialization quantum circuits, i.e. initialization unitaries, may be computed using a classical computer. In particular, at least some of the variational parameters (\vec{θ}ᵢₙᵢ⁽¹⁾ \vec{θ}ᵢₙᵢ⁽²⁾ may be determined based one or more initialization quantum circuits that are based on a classical simulable quantum circuit, i.e. a quantum circuit that can be classically simulated on a conventional computer. Classical simulable quantum circuits define quantum circuits that can be classically simulated on a conventional computer. Here, Clifford gates are the elements of the Clifford group, which is generated by three gates, Hadamard, CNOT, and the S gates. Clifford-gate quantum circuits, i.e. quantum circuits that only consist of Clifford gates, can be efficiently simulated with a classical computer. Other examples of classical simulable quantum circuits are quantum circuits that can be described in terms of single qubit operations such as single qubit rotations or matchgate circuits.

If for some settings of all variational parameters, the overall circuit may be described by a classical simulable quantum circuit, e.g. a Clifford-gate quantum circuit, the entire quantum circuit can be evaluated efficiently on a classical computer. Hence, in an embodiment, the features map quantum circuits [symbol] _{FM1}, [symbol] _{FM2}, . . . , the variational quantum circuits [symbol] ₁, [symbol] ₂, . . . and the initialization quantum circuits [symbol] ᵢₙᵢₜ₁, [symbol] ᵢₙᵢₜ₂, . . . may be designed in a parameterized way such that they can be set deterministically to a classical simulable quantum circuit. In that case, the variational angles may be computed classically in an efficient way on a classical computer. For example, by choosing the quantum circuit to have form [symbol] = [symbol] ₚ(\vec{θ}₁)^{†} [symbol] ₚ(\vec{θ}₂) and setting a relation between the variational parameters, for example \vec{θ}₁=\vec{θ}₂ then such variational the quantum circuit represents the identity operation, which is a Clifford operation and thus classically simulable.

Thus, by efficiently computing the non-trivial x-dependence in the output ƒ=ƒ(x) for a particular variational parameter setting of the quantum circuit, with some (free) variational parameters that do not cause the quantum circuit out of the space of the classical simulable quantum circuit, e.g. the Clifford-gate space, then ƒ can be fitted to a dataset in an efficient way. In particular, if the number of basis functions and tunable parameters of the classical simulable quantum circuit is only polynomial, then the dataset can be fitted in at most polynomial time to a satisfactory accuracy. After computing the values of the optimal variational parameters using a classical computer, the circuit can be initialized based on those values. Subsequently, all variational parameters can be optimized further by taking the quantum circuit out of the Clifford gate space.

FIG. 15 shows a workflow for initializing variational parameters of a variational quantum circuit based on a classical pre-processing or fitting step according to an embodiment of the invention. In a first step, a representation of a quantum circuit may be determined or provided, wherein the quantum circuit may include one or more quantum feature maps, one or more variational unitary quantum circuits associated with one or more variational parameters θ and one or more initialization unitary quantum circuits (step 1502) associated with initialization parameters θᵢₙᵢₜ. Then, a relation between at least part of the variational parameters may be set such that the overall quantum circuit becomes a classical simulable quantum circuit. The classical simulable quantum circuit may be simulated using a classical computer and the expectation values of the output may be computed (step 1504). Further, the dependent-variable dependence of ƒ(\vec{x}) as a function of initialization parameters θᵢₙᵢₜ may be determined (step 1508). Then, optimal values for initialization parameters θᵢₙᵢₜ may be determined. For example, a fitting algorithm such as regression may be used to fit ƒ optimally to a desired (estimate of the) solution (step 1510). Then, the quantum circuit may be initialized using the optimized θᵢₙᵢₜ values that were computed classically (step 1512), while the other angles were kept in the state that allow the quantum circuit to become a classical simulable quantum circuit. Finally, all parameters are variationally optimized in a variational optimization scheme until the output convergence towards the actual solution (step 1514).

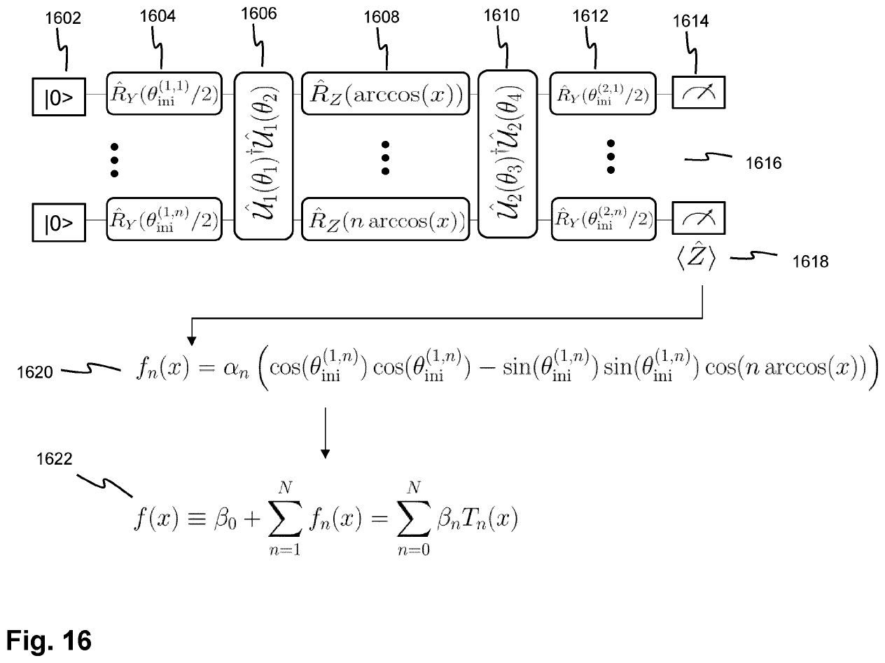

FIG. 16 depicts an example of an initialization strategy as described with reference to FIG. 14 and FIG. 15. The figure includes a quantum circuit describing a execution of qubit operations in time. In this example, the quantum circuit describes that qubits may be initialized in their ground state 1602 Thereafter, a single R_{y} rotation may be applied to each qubit indexed by n, wherein each rotation is associated with a unique rotation angle θᵢₙᵢ^{(1,n)}. Then, a unitary circuit [symbol] ₁(θ₁)^{†} [symbol] ₂(θ₂) 1606 may be applied to all qubits. Further, a feature map quantum circuit 1608 \hat{R}_{z} (n arccos(x)) may be applied to each qubit, wherein the pre-factor n in front of the arccos-function is determined by the qubit index. Then, another unitary circuit [symbol] ₂(θ₃)^{†} [symbol] ₂(θ₄) 1610 may be applied to each qubit and finally a layer of R_{y} rotations each with distinct parameters θᵢₙᵢ^{(2,n)} may be applied. Then, a cost function, e.g. the Z operator 1618 corresponding to a total magnetization cost function may be determined by measuring the output 1614 of every qubit independently.

Then, at least some of the variational parameters may be set such that the overall quantum circuit becomes a classical simulable quantum circuit. For example, if some of the variational parameters are initially set such that \vec{θ}₁=\vec{θ}₂ and \vec{θ}₃=\vec{θ}₄, those circuits reduce to the identity operator I. This makes the quantum circuit classically simulable, because effectively there is no entanglement between the qubits. This way, each expectation value can be computed separately. For qubit n, the expectation value ƒₙ (x)= [symbol] Cₙ [symbol] can be expressed as 1620, which is simply (as a function of x) a constant plus a cos(n arccos(x)) term with some coefficient, and all multiplied by an αₙ coefficient in front of the Z operator. That means that when all ƒₙ are summed together, the whole expression becomes ƒ(x) 1622 defining a sum over all Chebyshev polynomials up to order n, with a constant β₀ and with coefficients βₙ being some trivial function of the parameters θᵢₙᵢ^{(i,j)} and αₙ.

The Chebyshev polynomial function of degree n, 1622, can then be fitted to the function or data of interest, e.g. a certain approximation of function ƒ(x), with minimal classical overhead (providing a scaling of O(n)). After finding the optimal settings for variational parameters θᵢₙᵢ^{(i,j)} and αₙ, the full quantum circuit may be initialized based on those values on a real quantum computer. Then, the hybrid quantum-classical variational feedback loop of FIG. 6A may be used to manipulate angles \vec{θ}₁, \vec{θ}₂, \vec{θ}₃, \vec{θ}₄ vectors independently, such that the unitaries [symbol] ₁(θ₁)^{†} [symbol] ₂(θ₂) and [symbol] ₂(θ₃)^{†} [symbol] ₂(θ₄) are no longer the identity operators. These operations will start to mix all the Chebyshev terms Tₙ such that other orders appears alongside the n Tₙ terms that were started with (due to chaining and nesting). It is noted that although the embodiment of FIG. 16 aims to explain the initialization scheme in a specific setting, the initialization scheme described with reference to FIG. 14-16 will work for for any type of feature maps, variational Ansatze and cost function designs, as long as the overall cost function can be computed classically efficiently.

As already described with reference to FIGS. 2 and 6, to perform quantum machine learning such as DQC and solve relevant problems, first the data (quantum or classical) need to be encoded in a quantum register. For classical data quantum feature maps, where variables x are embedded through (nonlinearly transformed) phases of rotations or Hamiltonian evolution, are represented by a unitary operation. Then, following variational quantum algorithm workflow, such as the workflow depicted in FIG. 6, data may be manipulated by a trainable parameterized circuit. Variational parameters, often phases of unitary operators that form the quantum circuit are adjusted variationally based on a training objective defined by a loss function. Similar to classical machine learning, this is a non-convex optimization problem that requires a stable optimization schedule. In the field of classical deep learning, this was achieved by utilizing stochastic gradient descent and automatic differentiation (AD). Given the complexity of quantum optimization for data embedded in a Hilbert space and challenges of noisy operation (both physical and statistical), AD is vital for finding optimal parameters for quantum circuits. Automatic differentiation is also required for feature map differentiation and solving differential equations.

First a function may be designed as a circuit measurement on some operator C (equation B1):

$$f ( x ) = 〈 {ψ}_{\overline{θ}} \vert {\hat{U}}^{†} ( x ) {\hat{C}}_{\overline{θ}} \hat{U} ( x ) \vert {ψ}_{\overline{θ}} 〉 = 〈 ∅ \vert {\hat{V}}_{\overline{θ}}^{†} {e}^{+ i \frac{x}{2} \hat{G}} {\hat{W}}_{\overline{θ}}^{†} \hat{C} {\hat{W}}_{\overline{θ}} {e}^{- i \frac{x}{2} \hat{G}} {\hat{V}}_{\overline{θ}} \vert ∅ 〉 ,$$

It may be assumed that part of the circuit is made using feature maps of the form

$${e}^{- i \frac{x}{2} \hat{G}}$$

where Ĝ is a so-called generator of the features. Formal derivation of this expression yields the function derivative in terms of the commutator of the generator with the (effective) cost function (equation B2):

$$\frac{df ( x )}{dx} = \frac{i}{2} 〈 {ψ}_{\overline{θ}} \vert {e}^{+ i \frac{x}{2} \hat{G}} [ \hat{G} , {\hat{C}}_{\overline{θ}} ] {e}^{- i \frac{x}{2} \hat{G}} \vert {ψ}_{\overline{θ}} 〉 .$$

The generator Ĝ may be diagonalized such that it becomes diagonal and a sum of projectors P with eigenvalues λⱼ (equation B3):

$${G}_{†}^{} \hat{G} {G}_{} = {\sum }_{j} {λ}_{j} {\hat{𝒫}}_{j} = : \hat{D} ,$$

Combining equations B2 and B3 provides the following expression for the derivative without loss of generality (equation B4):

$$\begin{matrix}\frac{df ( x )}{dx} = \frac{d}{dx} 〈 {ψ}_{\overline{θ}} \vert ( {\sum }_{j = 1}^{d} {e}^{+ i \frac{x}{2} {λ}_{j}} {\hat{𝒫}}_{j} ) {\hat{C}}_{\overline{θ}} ( {\sum }_{{j}^{′} = 1}^{d} {e}^{- i \frac{x}{2} {λ}_{{j}^{′}}} {\hat{𝒫}}_{{j}^{′}} ) \vert {ψ}_{\overline{θ}} 〉 = \\ = \frac{i}{2} {\sum }_{j , {j}^{′} = 1}^{d} ( {λ}_{j} - {λ}_{{j}^{′}} ) {e}^{i \frac{x}{2} ( {λ}_{j} - {λ}_{{j}^{′}} )} 〈 {ψ}_{\overline{θ}} \vert {\hat{𝒫}}_{j} {\hat{𝒞}}_{\overline{θ}} {\hat{𝒫}}_{{j}^{′}} \vert {ψ}_{\overline{θ}} 〉\end{matrix} ,$$

A more compact notation of this expression can be provided (equation B5):

$$\frac{df ( x )}{dx} = {\sum }_{s = 1}^{S} {Δ}_{s} {R}_{s} \\ wherein \\ \begin{matrix}{R}_{s} = \frac{i}{2} {e}^{ix {Δ}_{s} / 2} {𝒪}_{s} - \frac{i}{2} {e}^{- ix {Δ}_{s} / 2} {𝒪}_{s}^{*} \\ = - sin ( \frac{x}{2} {Δ}_{s} ) Re \{ {𝒪}_{s} \} - cos ( \frac{x}{2} {Δ}_{s} ) Im \{ {𝒪}_{s} \}\end{matrix}$$

with the realization that all terms are real (since the function value is real, the derivative must be, too). There are s terms for s unique gaps in the generator spectrum. For each gap s, there are two terms, real and imaginary. The relationship between a shift in the function evaluation itself and all its higher-order derivatives is shown by the following expression (equation B6):

$$f ( x + δ ) = {\sum }_{n = 0}^{∞} \frac{{f}^{( n )} ( x ) {δ}^{n}}{n !} = {\sum }_{s = 1}^{S} exp [ i \frac{{Δ}_{s}}{2} ( x + δ ) ] {𝒪}_{s} + h . c .$$

One can easily show that this recovers the basic parameter-shift rule (equation B7) when two shifts are equal and opposite in sign:

$$\begin{matrix}f ( x + δ ) - f ( x - δ ) = {\sum }_{s = 1}^{S} ( {e}^{i \frac{δ}{2} {Δ}_{s}} - {e}^{- i \frac{δ}{2} {Δ}_{s}} ) {e}^{i \frac{x}{2} {Δ}_{s}} {𝒪}_{s} + h . c \\ = 4 {\sum }_{s = 1}^{S} sin ( \frac{{δΔ}_{s}}{2} ) {R}_{s}\end{matrix} , ($$

For general shifts, the same symmetry disappears and one would need twice more measurements. Below it is shown that for some feature maps and circuits used in DQC symmetries can be used to substantially reduce the number of circuit evaluations. Typically, feature maps represent a tensor product of rotations (parallel sequences) parameterized by the same variable X. One example corresponds to the product feature map that we define as (equation B8):

$$\hat{U} ( x ) = {⊗}_{j = 1}^{N} {\hat{R}}_{α , j} [ φ ( x ) ] , \qquad ( 14 )$$

where N is the number of qubits used for the encoding.

$${\hat{R}}_{α , j} ( φ ) = exp ( - i \frac{φ}{2} {\hat{P}}_{α , j} )$$

is a Pauli rotation operator for Pauli matrices \hat{P}_{α,j}=\hat{X}ⱼ, Ŷⱼ, or \hat{Z}ⱼ, (α=x, y, z) acting on qubit j with phase φ. For brevity, let us assume α=z, as other cases can be considered in the same way with additional Hadamard and phase gates before and after the feature map.

Equation B8 can be written in the form of

$${e}^{- i \frac{φ ( x )}{2} \hat{G}}$$

where the unitary operator is generated by the following generator (equation B9):

$${\hat{G}}_{Z} = {\sum }_{j = 1}^{N} {\hat{Z}}_{j} \qquad ( 15 )$$

that corresponds to a sum of Pauli operators. Being the total effective magnetization, the generator Ĝ_{z} in Equation B9 has a spectrum with N+1 eigenvalues Λ={−N, −N+2, . . . , 0, 2, . . . }. Some eigenvalues are multiply degenerate, and the number of unique positive gaps is S=|\hat{Γ}|=N. As the feature map can also be differentiated by applying the parameter shift rule individually to each rotation, the derivative can be measured using at most 2N circuit evaluations.

First, it is noted that eigenstates of Ĝ_{z} coincide with computational basis states and have all real amplitudes. Next, an input state |Ø [symbol] with real amplitudes may be considered, and ansatze \hat{V}_{θ}, Ŵ_{θ} that preserve this structure, such that |Ψ_{θ} [symbol] remains real. Finally, cost functions with real-valued matrix elements are considered, which can be formed by strings of Pauli X and Z operators, as well as strings with the even number of Pauli Y operators. Given the real structure of (variational) states and readout, the matrix elements [symbol] ₛ∈ [symbol] in equation B7 are real for any set of shifts { [symbol] }, and the difference considered in equation B7 can be expressed as follows:

$$f ( x + {δ}_{ℓ} ) - f ( x + {δ}_{{ℓ}^{′}} ) = 4 {\sum }_{s = 1}^{S} sin [ \frac{( {δ}_{{ℓ}^{′}} - {δ}_{ℓ} )}{4} {Δ}_{s} ] \times \times sin [ \frac{( 2 x + {δ}_{{ℓ}^{′}} + {δ}_{ℓ} )}{4} {Δ}_{s} ] Re \{ {𝒪}_{s} \} , \qquad ( 16 )$$

wherein the imaginary parts of matrix elements Im{ [symbol] ₛ} remain zero. As the number of unknown coefficients reduces by symmetry, it is sufficient to perform measurements at N+1 shifts (may include original function evaluation), reducing the budget of analytic derivative measurement from 2N evaluations required before for the single-qubit parameter shift rule. This halves the measurement time for function derivatives, and speeds up the solution for systems of differential equations.

So far the specific choices made can give reductions in the number of required measurements. Similarly, we can also imagine the situation where only imaginary parts are non-zero, or the matrix elements are complex-valued but have specific structure that connects real and imaginary parts (like in Kramers-Kronig relations that may be familiar to physicists).

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for solving one or more differential equations, DEs, using a data processing system comprising a classical computer system and a quantum computer system, the method comprising:
receiving or determining, by the classical computer system, a formulation of quantum circuits representing a trial function for the one or more DEs, the trial function being associated with one or more variables and a variable space, the quantum circuits including one or more function circuits for determining one or more values of the trial function around one or more points in the variable space, one or more derivative function circuits for determining one or more values of an derivative of the trial function around the one or more points and one or more quantum variational circuits associated with one or more optimization parameters;
executing, by the classical computer system, the quantum circuits for a set of points in the variable space of the trial function, wherein the execution of the quantum circuits includes: translating the quantum circuit into control signals for controlling quantum elements of the quantum computer system and for readout of the quantum elements to obtain hardware measurement data and controlling the quantum computer system based on the control signals;
receiving, by the classical computer system, in response to the execution of the quantum circuits, the hardware measurement data and processing the hardware measurement data into one or more trial functions and one or more derivatives of the one or more trial functions;
determining, by the classical computer system, on a basis of the one or more trial functions, the one or more derivatives of the one or more trial functions and a loss function, a score indicating how well the one or more measured trial functions satisfy the one or more DEs; and,
optimizing the loss function, the optimization including adjusting the one or more optimization parameters and repeating the execution of the quantum circuits, the processing of the hardware measurement data and the determination of a score, until the score meets a predetermined optimization condition.

2. The method according to claim 1 wherein the loss function is further based on one or more boundary conditions associated with the one or more DEs.

3. The method according to claim 2 wherein the one or more DEs include one or more parameterized DEs, and, wherein the loss function is further based on one or more boundary conditions associated with the one or more parameterized DEs and one or more data points.

4. The method according to claim 1, wherein the one or more DEs include one or more parameterized DEs, wherein a right hand side, RHS, term of the one or more parameterized DEs define a parameterized linear combination of functionals; and, wherein the loss function is further based on one or more boundary conditions associated with the one or more parameterized DEs and one or more data points.

5. The method according to claim 4 wherein the parameterized linear combination of functionals define as vector inner product [symbol] ·F, wherein [symbol] defines a parameter in the form of a vector of coefficients and F is a vector of functionals on ƒ and x,
$$( F ⌈ f , \frac{df}{dx} , x , … ⌉ )$$

6. The method according to claim 1 wherein the one or more DEs include one or more parameterized DEs, and these parameters are included as optimization parameters in the loss function optimization.

7. The method according to claim 1 wherein the control signals for controlling quantum elements of the quantum computer system include a sequence of pulses and wherein the control signals for readout of the quantum elements include applying a read-out pulse to the quantum elements of the quantum computer system.

8. The method according to claim 1, wherein the function circuits comprise a quantum feature map circuit for encoding a functional dependence on the one or more variables of the trial function, into quantum wave function amplitudes of the quantum elements of the quantum computer system.

9. The method according to claim 1 wherein the set of DEs determine a functional F represented by F[{dⁿƒ/dxⁿ}ₙ,{ƒₘ(x)}ₘ ]=0.

10. The method according to claim 1, wherein the hardware measurement data are measured as expectation values of a Hermitian cost.

11. The method according to claim 1 wherein the quantum circuits includes a plurality of different quantum sub-circuits, including one or more quantum feature map circuits, each quantum feature map circuit being configured to map a variable of the one or more DEs to a Hilbert space that is associated with the quantum element of the quantum computer system.

12. The method according to claim 1, wherein at least part of the one or more optimization parameters of the one or more quantum variational circuits is initialized based on initialization values that are classically computed based on a classically simulable version of the quantum circuit that is simulated on a classical computer.

13. The method according to claim 12 wherein the quantum circuits further comprise one or more initialization quantum circuits configured to initialize at least part of the one or more optimization parameters of the quantum circuit based on one or more initialization parameters, and wherein the classical simulation includes:
computing expectation values of an output of the classical simulable quantum circuit, the expectation values defining a function ƒ(\vec{x});
determining a dependent-variable dependence of ƒ(\vec{x}) as a function of initialization parameters \vec{θ}ᵢₙᵢ;
determining optimal values for the initialization parameters \vec{θ}ᵢₙᵢ, based on fitting ƒ(\vec{x}) to a desired solution or estimate thereof;
initializing the quantum circuit based the optimal values for the initialization parameters \vec{θ}ᵢₙᵢ, while keeping the other variational parameters fixed to define the classical simulable quantum circuit.

14. The method according to claim 11 wherein the one or more quantum feature quantum circuits and the one or more variational quantum circuits, and a cost function are configured to exhibit a symmetry.

15. A system for solving one or more differential equations, DEs, using a data processing system comprising a classical computer system and a quantum computer system:
receiving or determining, by the classical computer system, a formulation of quantum circuits representing a trial function for the one or more DEs, the trial function being associated with one or more variables and a variable space, the quantum circuits including one or more function circuits for determining one or more values of the trial function around one or more points in the variable space, one or more derivative function circuits for determining one or more values of an derivative of the trial function around the one or more points and one or more quantum variational circuits associated with one or more optimization parameters;
executing, by the classical computer system, the quantum circuits for a set of points in the variable space of the trial function, wherein the execution of the quantum circuits includes: translating the quantum circuit into control signals for controlling quantum elements of the quantum computer system and for readout of the quantum elements to obtain hardware measurement data and controlling the quantum computer system based on the control signals;
receiving, by the classical computer system, in response to the execution of the quantum circuits, the hardware measurement data and processing the hardware measurement data into one or more trial functions and one or more derivatives of the one or more trial functions;
determining, by the classical computer system, on the basis of the one or more trial functions, the one or more derivatives of the one or more trial functions and a loss function, a score indicating how well the one or more measured trial functions satisfy the one or more DEs; and,
optimizing the loss function, the optimization including adjusting the one or more optimization parameters and repeating the execution of the quantum circuits, the processing of the hardware measurement data and the determination of a score, until the score meets a predetermined optimization condition.

16. The system according to claim 15 wherein the loss function is further based on one or more boundary conditions associated with the one or more DEs.

17. A computer program or suite of computer programs comprising at least one software code portion or a computer program product storing at least one software code portion, the software code portion, when run on a classical computer system wherein the classical computer, system is part of a data processing system comprising the classical computer system connected to a quantum computer system, being configured for executing the method steps according claim 1.

18. A quantum learning method using a data processing system comprising a classical computer system and a quantum computer system, the method comprising
providing or determining a quantum circuit, the quantum circuit including a plurality of different quantum sub-circuits, including one or more quantum feature map circuits, each quantum feature map circuit being configured to map a variable of a solution to a mathematical problem to a Hilbert space that is associated with a quantum element of a quantum computing system and one or more variational quantum circuits associated with one or more variational parameters for training the quantum circuit to approximate a solution to the mathematical problem, the method including:
initializing at least part of the one or more variational parameters of the one or more variational quantum circuits based on initialization values that are classically computed based on a classically simulable version of the quantum circuit that are simulated on a classical computer; and,
variationally optimizing the quantum circuit based on the variational parameters until a predetermined convergence of an output of the quantum circuit with the solution is determined.

19. The quantum learning method according 18, wherein the method is configured to train the quantum circuit to approximate a solution to one or more differential equations, DEs, and wherein variationally optimizing the quantum circuit includes solving one or more differential equations, DEs, using a data processing system comprising a classical computer system and a quantum computer system, the method comprising:
receiving or determining, by the classical computer system, a formulation of quantum circuits representing a trial function for the one or more DEs, the trial function being associated with one or more variables and a variable space, the quantum circuits including one or more function circuits for determining one or more values of the trial function around one or more points in the variable space, one or more derivative function circuits for determining one or more values of an derivative of the trial function around the one or more points and one or more quantum variational circuits associated with one or more optimization parameters;
executing, the classical computer system, the quantum circuits for a set of points in the variable space of the trial function, wherein the execution of the quantum circuits includes: translating the quantum circuit into control signals for controlling quantum elements of the quantum computer system and for readout of the quantum elements to obtain and measurement data and controlling the quantum computer system based on the control signals;
receiving, by the classical computer system, in response to the execution of the quantum circuits, the hardware measurement data and processing the hardware measurement data into one or more trial functions and one or more derivatives of the one or more trial functions;
determining, by the classical computer system, on the basis of the one or more trial functions, the one or more derivatives of the one or more trial functions and a loss function, a score indicating how well the one or more measured trial functions satisfy the one or more DEs; and,
optimizing the loss function, the optimization including adjusting the one or more optimization parameters and repeating the execution of the quantum circuits, the processing of the hardware measurement data and the determination of a score, until the score meets a predetermined optimization condition.
